(19) United States
(12) Patent Application Publication
(10) Pub. No.: US 2003/0063779 A1
(43) Pub. Date: Apr. 3, 2003

(54) System for visual preference determination and predictive product selection

(76) Inventor: Jennifer Wrigley, San Francisco, CA (US)

Correspondence Address: Martin C. Fliesler, FLIESLER DUBB MEYER & LOVEJOY LLP, Fourth Floor, Four Embarcadero Center, San Francisco, CA, 94111-4156, US

(21) Appl. No.: 10/113,833

(22) Filed: Mar. 29, 2002

Related U.S. Application Data
(60) Provisional application No. 60/280,323, filed on Mar. 29, 2001.

(51) Int. Cl. G06K 9/00

(52) U.S. Cl. 382/116

(57) ABSTRACT

The present invention uses a combination of image decomposition, behavioral data and a probability engine to provide products, which are closest to a consumer's personal preference. This personal preference is referred to as “taste-based technology”. Taste-based technology uses three key components: image analyzer, behavior tracking and predication engine. The image analyzer uses a number of techniques to decompose an image into a number of image signatures, and then places those signatures into a database for later analysis and retrieval. The techniques used include: storing geometric descriptions of objects of the domain, which are matched with extracted features from the images; processing data from lower abstraction levels (images) to higher levels (objects); and processing data that are guided by expectations from the domain. This decomposed data can be used as standalone data (i.e. in a non-web environment) or fed into the prediction engine for real-time consumer preference determination.

### CLAIM OF PRIORITY

This application claims priority from provisional application “SYSTEM FOR VISUAL PREFERENCE DETERMINATION AND PREDICTIVE PRODUCT SELECTION” Application No. 60/280,323, filed Mar. 29, 2001, which application is incorporated herein by reference.

### FIELD OF THE INVENTION

The invention relates generally to predictive systems and to methods for predicting consumer preferences in a visual environment.

### BACKGROUND OF THE INVENTION

In recent years, the growing usage of the Internet has provided many opportunities for electronic commerce or e-commerce. Foremost among the many e-commerce trends is the business to consumer(B2C) marketplace, and business to business (B2B) interoperability. B2C applications typically involve selling a business's products or services to a customer. They represent the electronic equivalent of the old corner store stocking a wide variety of products for the prospective customer's perusal. However, most current e-commerce systems are lacking in that they don't match up to the personalization abilities of the old corner store. Whereas the traditional storekeeper often knew his/her customer on a personal basis, knew their tastes and preferences, and was often able to make shopping suggestions based on that knowledge, the current e-commerce offerings typically amount to a bland warehouse style of selling. The typical e-commerce B2C application knows nothing about the customer's tastes or preferences and as such makes no attempt to tailor the shopping experience to best suit them. The customer may thus feel underserved, and often disappointed when faced with a selection of products that obviously don't match their personal tastes or preferences.

In order for e-commerce providers to remain successful (or in many cases to remain in business), they must ideally incorporate some measure of personalization into their applications. This personalization creates brand loyalty among their customers, eases the customers' shopping experience, and may induce the customer to buy additional items they hadn't even considered. The analogy is the traditional store owner who, knowing his regular customers very well, is able to recommend new products for them to try out, based on his/her knowledge of both their former buying record, individual personality, and willingness to try new things.

Several techniques currently exist for attempting to bring customer personalization and predictive methods to the e-commerce world. Most, such as that used by Amazon.com, attempt to predict a customer's likelihood to buy a product based on their past buying history. This method, of course, only works when the company can exactly identify the customer - it doesn't work very well for new or prospective customers, perhaps at home or school, since the prevalence of cookies often means that a customer is often identified solely by the machine they use.

Another commonly-used method is to associate the customer with a profile—a statistical indicator as to what demographic group they belong to. Shopping inferences may then be based on averages for this group. Of course, it stands to reason that individuals and their shopping preferences are rarely, if ever, accurately indicated by group averages. Profiling methods typically also suffer the disadvantage of requiring a user to preregister in some way, so as to provide an initial input to creating the profile. One method of doing this is to request a user to enter some descriptive information, for example their age and zip code, when they try to access a particular web page. If the user does provide this information (and the information provided is in fact correct) then a cookie can be placed in that user's browser, and that cookie used to retrieve profile information based on the age and zip code data. However, since this cookie is tied with the actual machine or browser it does not accurately reflect the actual user's profile-and in cases where multiple users use the same machine this method invariably fails.

A noticeable problem with all of the above methods is that they typically require preregistration of the user in some manner. This may be a direct registration (as in the case of an existing customer) or a surreptitious registration, based in the form of a questionnaire. As such they cannot operate in real-time, accurately monitoring a current user's preferences and reacting accordingly. Nor can they typically support situations in which multiple users use a single machine, web browner, or email address. They further suffer the disadvantage in that their methods of registration and profiling are hard-wired, attempting to define a user's shopping preferences in terms of a limited set of assigned variables, but individual preferences typically blur the lines between such variables, and are better defined in terms of individual taste, a subjective notion that cannot easily be assessed using current methods.

In order for the current e-commerce providers, particularly in the B2C world but also in the B2B sector, to survive and extend their services to include the best aspects of the old corner store methods, a new technology is needed that combines predictive techniques with the ability to assess and conform to a user's personal shopping tastes.

### SUMMARY OF THE INVENTION

The invention seeks to provide a predictive technology that takes into account an individual user's personal taste. Furthermore, embodiments of the invention can perform this task in real-time, and independently of the system, web browser, or email address used by the user. The invention has obvious applications in the B2C shopping market, but has widespread application in the entire e-commerce marketplace, and in any field that desires customized content provision to a number of individual users. These fields include, for example, news, media, publishing, entertainment and information services.

The initial development of the invention was designed to satisfy a particular need. Over the past several years the inventors, who are also avid artists, have used various sources of inspiration for their creations, one of which being the Internet, and its supposedly rich content of other's work. However, they discovered a problem. There was very little in the way of Internet art images. The Internet was primarily made up of textual descriptions of artwork and not visual data. That's when the inventors came up with the idea of a visually-driven art site on the Internet and ArtMecca was born.

ArtMecca is only one example of the use of the invention in an e-commerce environment. In the ArtMecca example, a series of images from different painters or other artists can be loaded into the system and analyzed. A shopper can browse or search through the system to find a painting or other art object which they like. They can then purchase the painting or artwork direct from the company or from the painter themselves. A key distinction between the inventive system and the old style of site is that the invention is able to predict a likely set of tastes or preferences of a potential customer, and structure its display of product inventory accordingly. To accomplish this, an image analyzer is first used to evaluate and assign variables to a particular piece of art. A prediction engine calculates the probability of a potential buyer liking a particular art piece, and a behavioral tracking system is used to guide or assist the process.

Although ArtMecca.com was initially conceived with the goal of exhibiting the artwork of just a few painters, the inventors quickly recognized a global business opportunity in exhibiting the work of a very large number of artists online. As their site grew and evolved, it became apparent that the sheer size of ArtMecca's expanding inventory and the limitations of textual descriptions required a new approach to matching buyers with visually oriented products. After an exhaustive search of the market, it was determined that no solution existed, motivating the inventors to develop their own state-of-the-art visual-based prediction software suite utilizing their image understanding methodology. The technology has applications in all areas of e-commerce and human-machine interface.

In order to succeed in today's competitive market, online companies must engage the consumer quickly with products and images that are relevant to the consumer's personal interests. Web-based sales channels are required to immediately match appropriate products to prospective and repeat consumers by understanding each consumer's online behavior. The visual images, not the textual descriptions, of these products are a more effective approach for attracting consumers. Additionally, the visual image of a product elicits a more accurate response of a consumer's interest in the item.

The application for the visual preference system's taste-based technology is to predict a consumer's individual taste by analyzing both the consumer's online behavior and response to one-of-a-kind visual images. Because a person's taste does not change significantly across fields, the visual preference system enables a company to determine what a specific consumer likes across various product groups, mediums and industries.

Images are very powerful influences to a consumer's behavior-an image creates an emotional response that instantly engages or disengages the consumer. When the image is relevant to the consumer's personal taste and preferences, it becomes a direct source to increase the consumer's interest and enjoyment. Because consumers are only one click away from the next online company, ensuring the image evokes a positive response is critical to increasing customer retention and increasing sales.

In order to produce a successful recommendation, companies must quantitatively understand the images a consumer is viewing and analytically understand the consumers' click steam behavior in response to the image. By understanding these two components, companies can accurately predict and influence consumer's behavior. Without this ability to help focus the potential buyer, the consumer will become frustrated by the large selection of images and lose interest after viewing non-relevant products.

Designed for heterogeneous products such as art, jewelry or homes, the visual preference system's taste-based technology personalizes the online experience to that individual consumer's preferences without requiring any explicit effort by the consumer, e.g., ranking products, logging in or making a purchase. With the visual preference system, a company seamlessly learns and adjusts to each consumer's preference, creating a more relevant environment that becomes more powerful each minute the consumer browses.

The visual preference system introduces a ground-breaking approach for the prediction of a consumer's taste, called taste-based technology. The predictive features of the visual preference system and the foundation of the product's belief networks are based on a fundamental principal of logic known as Bayes' Theorem. Properly understood and applied, the Theorem is the fundamental mathematical law governing the process of logical inference. Bayes' Theorem determines what degree of confidence or belief we may have in various possible conclusions, based on the body of evidence available.

This belief network approach, also known as a Bayesian network or probabilistic causal network, captures believed relations, which may be uncertain, stochastic, or imprecise, between a set of variables that are relevant to some and are used to solve a problem or answer a question. The incorporation of this predictive reasoning theorem, in conjunction with the visual preference system's behavioral and image algorithms, permits the visual preference system to offer the most advanced taste-based technology.

The visual preference system technology incorporates three key components: behavioral tracking, image analyzer and a predication engine. The behavioral tracking component tags and tracks a consumer as he or she interacts with the Web site and inputs the data into the prediction engine. The image analyzer runs geometric and numeric information on each image and inputs the data into the prediction engine. The predication engine utilizes algorithms to match digital images to consumer behavior, and interfaces with the consumer in real-time. Designed for use across the Internet, the visual preference system is available on multiple platforms, including web-based, client-server and stand-alone PC platforms.

The visual preference system prediction engine consists of three distinct sections of operations: 1) image analyzer, 2) behavior tracking, and 3) prediction engine.

A visual task is an activity that relies on vision—the “input” to this activity is a scene or image source, and the “output” is a decision, description, action, or report. To automate these hard-to-define, repetitive and evolving processes for image understanding, the visual preference system has developed proprietary technology that delivers the right product to the right buyer in real-time.

The challenge of the Image analyzer is to automatically derive a sensible description from an image. The application within which the description makes sense is called the “domain characteristics of interest.” Typically, in a domain there are named objects and characteristics that can be used to make a decision; however, there is a wide gap between the nature of images (arrays of numbers) and descriptions. It is the bridging of this gap that has kept researchers very busy over the last two decades in the fields of Artificial Intelligence, Scene Analysis, Image Analysis, Image Processing, and Computer Vision. Today the industry has summarized these fields as Image Understanding Research.

The visual preference system technology has automated the process of analyzing and extracting quantitative information from images and assigning unique image signatures to each image. In order to make the link between image data and domain descriptions, the visual preference system extracts an intermediate level of description, which contains geometric information. The visual preference system begins processing a batch of images and emphasizes key aspects of the imagery to refine the domain characteristics of interest. Then, events are extracted from the images, which characterize the information needed for description.

These events are stored at the intermediate level of abstraction in the visual preference system database, and referred to as “image characteristics.” These descriptions are free of domain information because they are not specifically objects or entities of the domain of understanding. Instead, the descriptions contain geometric and other information, which the visual preference system uses to analyze and interpret the images.

Image analyzer utilizes a number of techniques to interpret the geometric data and images, including Model Matching, Bottom-Up and Bottom-Down techniques. The techniques are specified using algorithms that are embodied in executable programs with appropriate data representations. The techniques are designed to:

Model Matching: stores geometric descriptions of objects of the domain, which are matched with extracted features from the images.

Bottom-Up: processes data from lower abstraction levels (images) to higher levels (objects).

Top-Down: processes data that is guided by expectations from the domain

In order to activate the behavioral tracking, consumers simply enter a web site domain. Once at the site, the visual preference system tracts implicit (browsing) and explicit (selecting/requesting) behaviors in a relational database and a sequential log (e.g. append file). The visual preference system separates the two tracking methods to assure faster real-time prediction and a complete transactional log of information that stores activities. The transactional log allows the visual preference system to mine the data for all types of information to enhance the targeted personal behaviors. Once the data is available in the system, the visual preference system:

Analyzes the individual

Classifies the preferred interest

Clusters the individual with those of similar behaviors

First-time consumers benefit from starting with a predictable preference based on a pre-analysis of demographic information obtained from other shoppers and its popular preferences. Each consumer is uniquely tagged as an individual shopper and each visit is tagged and stored for that consumer. This information allows the visual preference system to answer questions for each consumer—how often does the consumer visit, what is the consumer viewing on each visit, what is the path (pattern) of viewing or buying, etc. In some embodiments the consumer may be identified thereafter by a cookie stored on their machine or browser, or by retrieving personal information such as a login name or their email address. The combination of using such data as machine-based cookies and user personal information allows the system to track users as they switch from one machine to another, or as multiple users work on a single machine, and to react accordingly.

The visual preference system prediction engine uses individual and collective consumer behavior to define the structure of the belief network and provide the relations between the variables. The variables, stored in the form of conditional probabilities, are based on initial training and experience with previous cases. Over time, the network probability is perfected by using statistics from previous and new cases to predict the mostly likely product(s) the consumer would desire.

Each new consumer provides a new case—a set of findings that go together to provide information on one object, event, history, person, or other thing. The goal is to analyze the consumer by finding beliefs for the un-measurable “taste/preference” variables and to predict what the consumer would like to view. The prediction engine finds the optimal products for that consumer, given the values of observable variables such as click behaviors and image attributes.

Browsing online for most consumers is usually random in nature, and arguably unpredictable. With no prior historic data, it is unlikely any system can confidently state what products the consumer will select without first understanding the consumer's selection, characteristic of those selections and the probability of those selections. The visual preference system can overcome the short-term challenges for prediction of taste for the first-time consumer. By focusing on the available probabilities, the visual preference system make knowledgeable and accurate predictions, which continue to improve with each activity.

Together, the image analyzer, behavior tracking and the prediction engine increase consumer retention and the conversion rate between browsers and buyers. The visual preference system's taste-based technology is effective for all online as well as offline image catalog products. It is most effective for one-of-a-kind products that are not easily repeatable in the market. For example, if a consumer were to purchase an original impressionist oil painting of a blue flower, they probably would not want more impressionist oil paintings of a blue flower when purchasing additional pieces of artwork. Predicting other products that the consumer may want by finding patterns of interest enables a more value-added experience for that consumer, increasing the likelihood of additional purchases. Because art offers one of the most complex processes for predicting tastes, the visual preference system team developed a consumer Web site called ArtMecca.com where they developed, tested and implemented the visual preference system technology. Refer to http://www.artmecca.com for a demo.

The visual preference system model for taste-based technology enables companies to anticipate the market and increase sales among new and repeat consumers. Created for unique items that are graphically focused, the visual preference system presents benefits to both consumers and companies.

Immediate Analysis: Unlike collaborative filtering technology, which examines a consumer's behavior after a purchase is made or requires a consumer to input personal data, the visual preference system begins predicting taste once a consumer begins browsing and viewing a Web site.

Graphic Focus: Previous technologies require the system to translate intricate graphical images into basic textual forms. The visual preference system does not convert visual images into words-it understands the graphical components of the visual image, creating a superior understanding of the product's attributes. As a result the visual preference system is able to better understand the elements of a product that a consumer would like or dislike.

Faster Browsing: Because the visual preference system predicts a consumer's likes and dislikes immediately, the system is able to introduce relevant products. Consumers are not forced to view products that do not interest them in order to reach relevant products.

The combination of these benefits improves consumer retention and increases the conversion rate of browsers into buyers. In today's online market where competitors are one click away, the visual preference system taste-based technology offers a pragmatic approach for attracting consumers, retaining customers and converting browsers into buyers. The visual preference system's framework is applicable to a vast array of products, especially those items that are one of a kind.

The visual preference system's taste-based technology enables a client to better understand their consumer's personal likes and dislikes. Designed for image-based products such as art, furniture, jewelry, real estate, textiles and apparel, The visual preference system's taste-based technology personalizes the online experience to an individual consumers preferences without requiring any explicit effort by the consumer. The visual preference system technology learns and adjusts to the consumer, and then compares the data with information gained from a community sharing similar interests and tastes. In real-time, the visual preference system interfaces with the consumer, delivers images that match the consumer's personal tastes and enables businesses to quickly provide the right product to the right customer.

### BRIEF DESCRIPTION OF THE DRAWINGS:

FIG. 1 shows the general layout of a visual preference system, including a behavioral tracking component, an image analyzer component, and a prediction engine.

FIG. 2 shows the high-level layout of the image analyzer component.

FIG. 3 shows the steps used by the image-pre-processor in determining image signatures.

FIG. 4 shows a schematic overview of the image processing routines.

FIG. 5 illustrates a high-level overview of the behavioral tracking component.

FIG. 6 illustrates the steps involved in the classification process.

FIG. 7 illustrates schematically the clustering of individuals with those others having similar behaviors.

FIG. 8 shows the steps in the cluster analysis that divides the space into regions characteristic of groups that it finds in the data.

FIG. 9 illustrates a high-level overview of the prediction system in accordance with an embodiment fo the invention.

FIG. 10 shows steps in the method of prediction if the posterior probability is available.

FIG. 11 shows steps in the method of prediction if the posterior probability is not available.

FIG. 12 illustrates an image variable tree.

FIG. 13 illustrates an example of the CPT structure.

FIG. 14 illustrates an example of the type of browse data collected by the system.

FIGS. 15-26 illustrate an example of how the system may be used to construct a website in accordance with an embodiment of the invention.

FIG. 27 shows an example f the type of data associated with an image, in accordance with an embodiment of the invention.

FIGS. 28-35 illustrate how in one embodiment, the various images are classified and processed for use with the visual preference system.

FIG. 36 illustrates a sample prior probability data.

### DETAILED DESCRIPTION

The world is a visual environment. To make decisions, people often rely first and foremost upon their sense of sight. The invention allows this most fundamental human activity of making choices with our eyes to be re-built for the marketplace, with the addition of a proprietary technology that quantifies, streamlines, and monetizes the process. Consider the following scenarios:

“Here are the wallpaper books, fabric swatches, and tile samples you'll need to start choosing décor for your new kitchen.”

“Mom, Dad ... all the kids at school have new high tops with neon green soles; I want a pair too, but I might want the silver ones with the stripe.”

“The Art Director just told me to find the best 5 or 6 images of ‘cows in a field’ for this afternoon's meeting, and we now have 2 hours to search 6 million stock images on file.”

The common thread in these examples is the opportunity for a visual preference system. The visual preference system as embodied in the invention interprets and quantifies an individual's natural tendency to make purchasing decisions based on the way objects and products look. Moreover, the visual preference system has expanded on this core functionality by including a sophisticated taste-based technology, which not only quantifies a buyer's visual preferences, but predicts a buyer's individual tastes and purchasing patterns. By analyzing the quantitative variables of images passing before a consumer's eyes, and then correlating these variables to the consumer's ongoing viewing behavior and ultimate purchasing choices, taste-based technology can identify the important relationship between what a person sees, and what a person will want to buy.

Designed primarily for image-based products such as art, furniture, jewelry, real estate, textiles, and apparel, the visual preference system's taste-based technology personalizes and improves an individual buyer's experience of sifting through an online inventory or clicking through a catalog, without requiring any explicit effort on the part of the buyer. In short, taste-based technology helps the buyer find what he or she likes faster, more accurately, and more enjoyably. For the seller, this means higher conversion rates, higher average sales and significantly higher revenues throughout the lifecycle of each customer. The visual preference system's software is effective in online and offline environments such as manufacturing, biotechnology, fashion, advertising, and art, as well as anywhere that image differentiation is crucial to the purchasing or matching process.

As a system designed to analyze, interpret, and match graphic representations of objects (artwork, furniture, jewelry, real estate, textiles, apparel, etc.), the visual preference system's taste-based technology exceeds in every category the utility of existing text-reliant personalization and recommendation software.

Visual Focus: Existing technology strain to translate intricate digital images into basic textual formats. The visual preference system takes an entirely different approach: rather than converting visual images into words, it directly perceives the graphical components of the visual image itself, creating a superior understanding of the product's attributes. As a result, the visual preference system is able to far better match a product's attributes to the tastes of individual buyers.

Real-Time Analysis: Unlike collaborative filtering technology, which examines a buyer's behavior after a purchase is made, or requires a buyer to input personal data before a match can even be suggested, the visual preference system begins predicting the instant a buyer begins browsing a site.

Relevant Browsing: Because the visual preference system predicts a buyer's likes and dislikes immediately, the system is able to introduce relevant products from the very start of an online session. Buyers are not first forced to view products that do not interest them in order to progress along the system's learning curve and finally reach relevant products that do interest them.

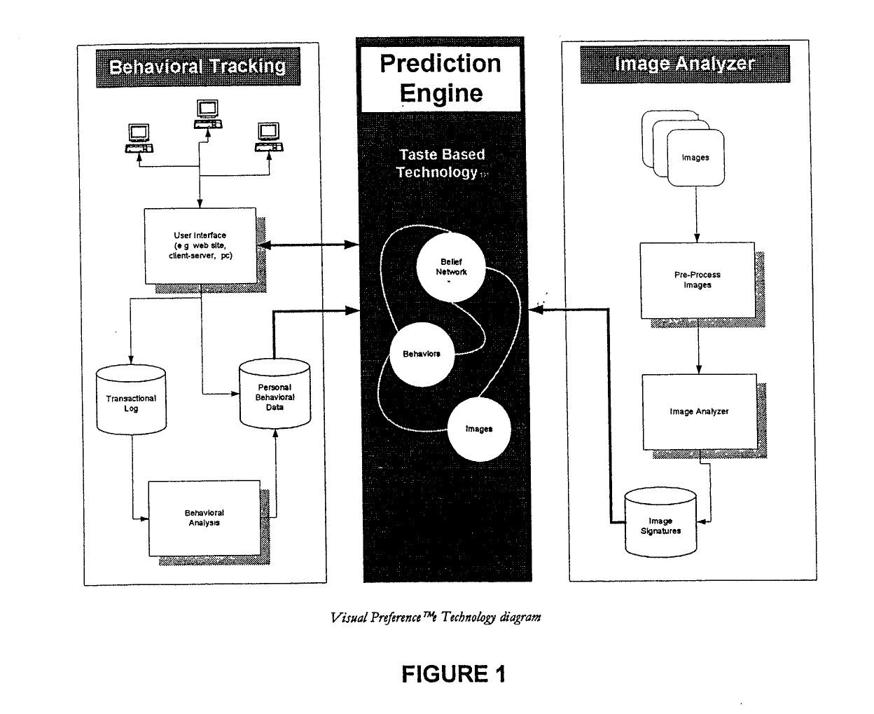

The aggregate effect of these benefits is to improve buyers' retention and increase the conversion rate between browsers and buyers. The visual preference system technology incorporates three key components: a behavioral tracking component, an image analyzer component, and a prediction engine. The general placement of these components are shown in FIG. 1. The behavioral tracking component tags and tracks a consumer as he or she interacts with a site, inputting this data into the prediction engine. The image analyzer runs geometric and numeric information on each image viewed by the consumer, funneling this data into the prediction engine. The prediction engine then utilizes algorithms to match digital images to consumer behavior, and interfaces with the consumer in real-time. An embodiment of the visual preference system is designed primarily for Internet or Web application but other embodiments are available for multiple platforms, including client-server and stand-alone PC platforms.

The predictive features of the visual preference system and the foundation of the product's belief networks are based on a fundamental principal of logic known as Bayes' Theorem. Properly understood and applied, the theorem is the fundamental mathematical law governing the process of logical inference. Bayes' Theorem determines what degree of confidence or belief we may have in various possible conclusions, based on the body of evidence available.

This belief network approach, also known as a Bayesian network or probabilistic causal network, captures believed relations, which may be uncertain, stochastic, or imprecise, between a set of variables that are relevant to some and are used to solve a problem or answer a question. The incorporation of this predictive reasoning theorem, in conjunction with the visual preference system's behavioral and image algorithms, permits the visual preference system to offer a new wave of personalization technology.

Image Analyzer

A visual task is an activity that relies on vision—the input to this activity is a scene or image source, and the “output” is a decision, description, action, or report. To automate these hard-to-define, repetitive and evolving processes for image understanding, the visual preference system provides a technology that delivers the right product to the right buyer in real-time.

The challenge of the image analyzer is to automatically derive a sensible description from an image. The application within which the description makes sense is termed the domain characteristics of interest. Typically, in a domain there are named objects and characteristics that can be used to make a decision. However, there is a wide gap between the nature of images (which are represented by arrays of numbers), and descriptions. It is the bridging of this gap that has kept researchers very busy over the last two decades in the fields of Artificial Intelligence, Scene Analysis, Image Analysis, Image Processing, and Computer Vision. Today the industry has summarized all of these fields within the field of Image Understanding research.

The visual preference system technology in accordance with the invention has automated the process of analyzing and extracting quantitative information from images and assigning unique image signatures to each image. In order to make the link between image data and domain descriptions, the visual preference system extracts an intermediate level of description, which contains geometric information. The visual preference system begins processing a batch of images and emphasizes key aspects of the imagery to refine the domain characteristics of interest. Then, events are extracted from the images, which characterize the information needed for description.

These events are stored at the intermediate level of abstraction in the visual preference system database, and referred to as image characteristics. These image characteristics descriptions are free of domain information because they are not specifically objects or entities of the domain of understanding. Instead, the descriptions contain geometric and other purely objective information, which the visual preference system uses to analyze and interpret the images.

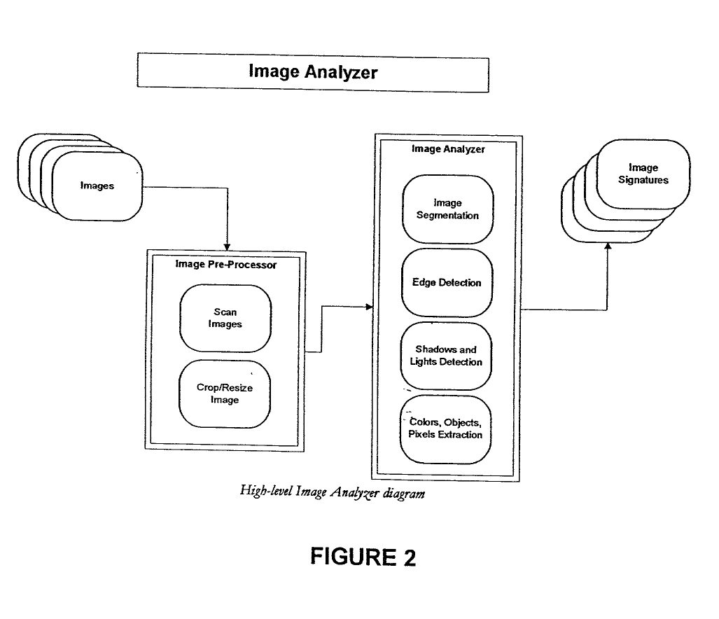

The high-level layout of the image analyzer component is shown in FIG. 2. The image analyzer utilizes a number of techniques to interpret the geometric data and images, including Model Matching, Bottom-Up and Bottom-Down techniques. The techniques are specified using algorithms that are embodied in executable programs with appropriate data representations. The techniques are designed to perform the following:

Model-Matching: stores geometric descriptions of objects of the domain, which are matched with extracted features from the images.

Bottom-Up: process data from lower abstraction levels (images) to higher levels (objects).

Top-Down: processes data that is guided by expectations from the domain

The terms model-matching, bottom-up and top-down are well known to one skilled in the art. The image pre-processor stage uses manual and automated processes to standardize the image quality and image size prior to the image analysis stage. An image-editing tool is used to batch images for the purpose of resizing and compressing the images.

An embodiment of the visual preference system image analyzer application utilizes various DLLs and ActiveX software component toolkit to extract the necessary image segmentation data as input to the prediction engine. These toolkits can provide application developers with a large library of enhancement, morphology, analysis, visualization, and classification capabilities and allow further expansion and customization of the system as needed. Appendix A includes descriptions of some of the image processing features available. The features shown therein are well known to one skilled in the art.

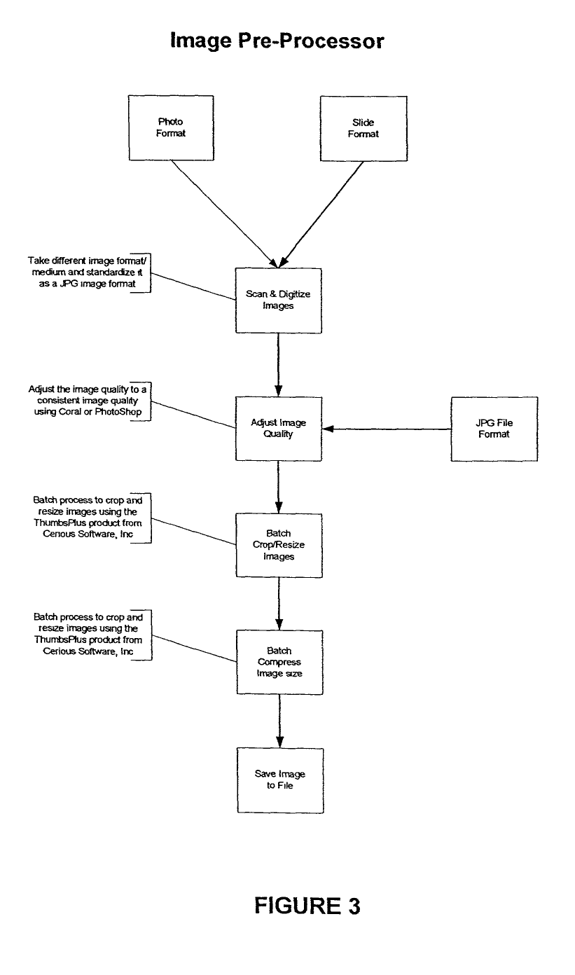

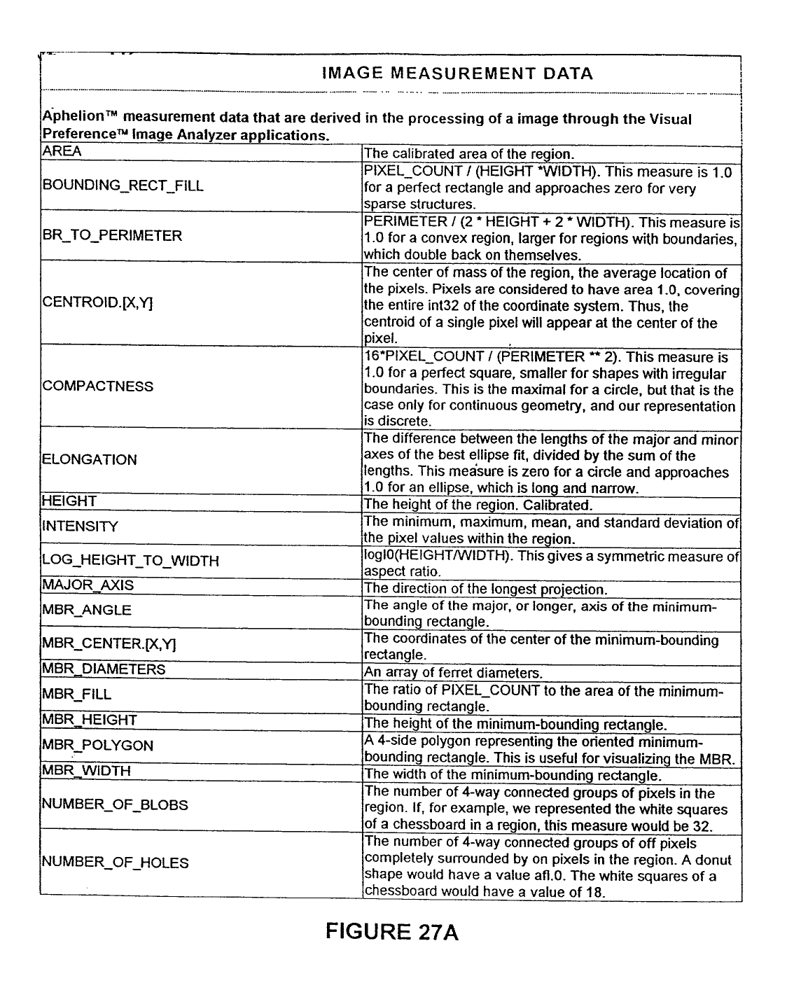

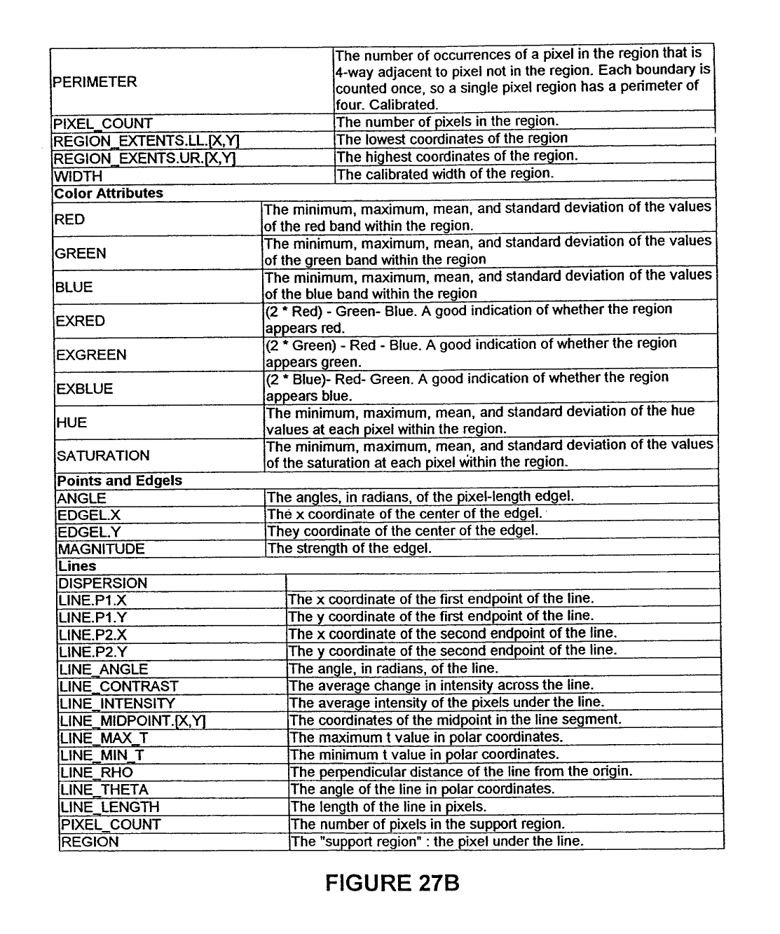

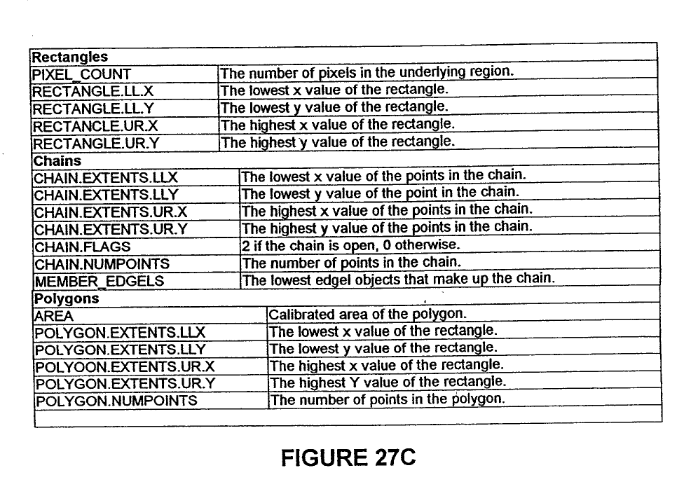

FIG. 3 shows steps used by the image pre-processor in determining image signatures. The image is first scanned, sized and compressed before saving it to a file. An example of the type of information recorded for each image is discussed in detail below, and also shown in FIG. 27.

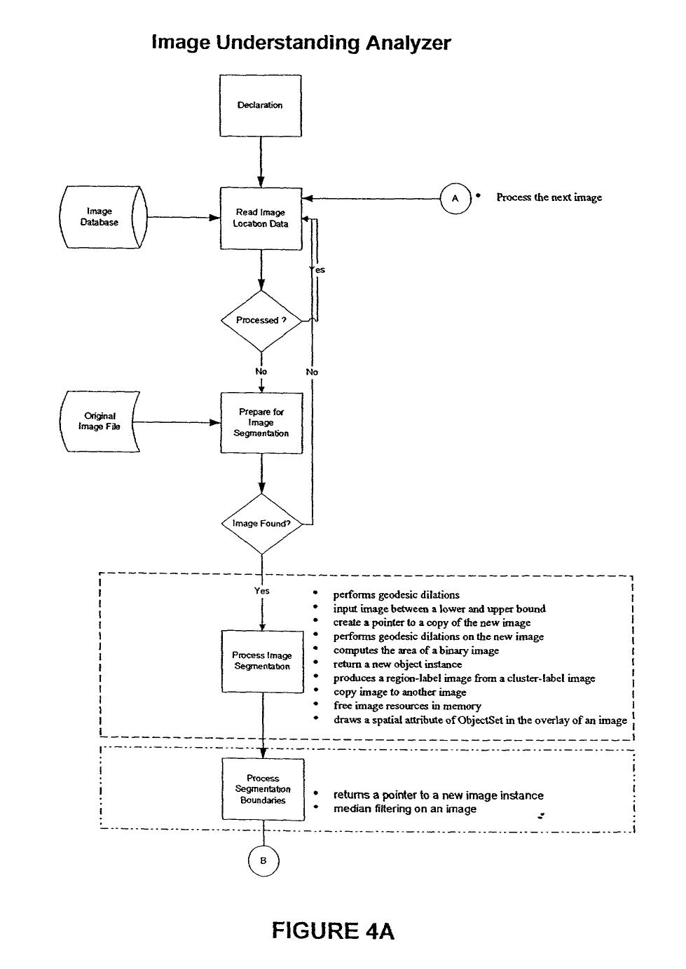

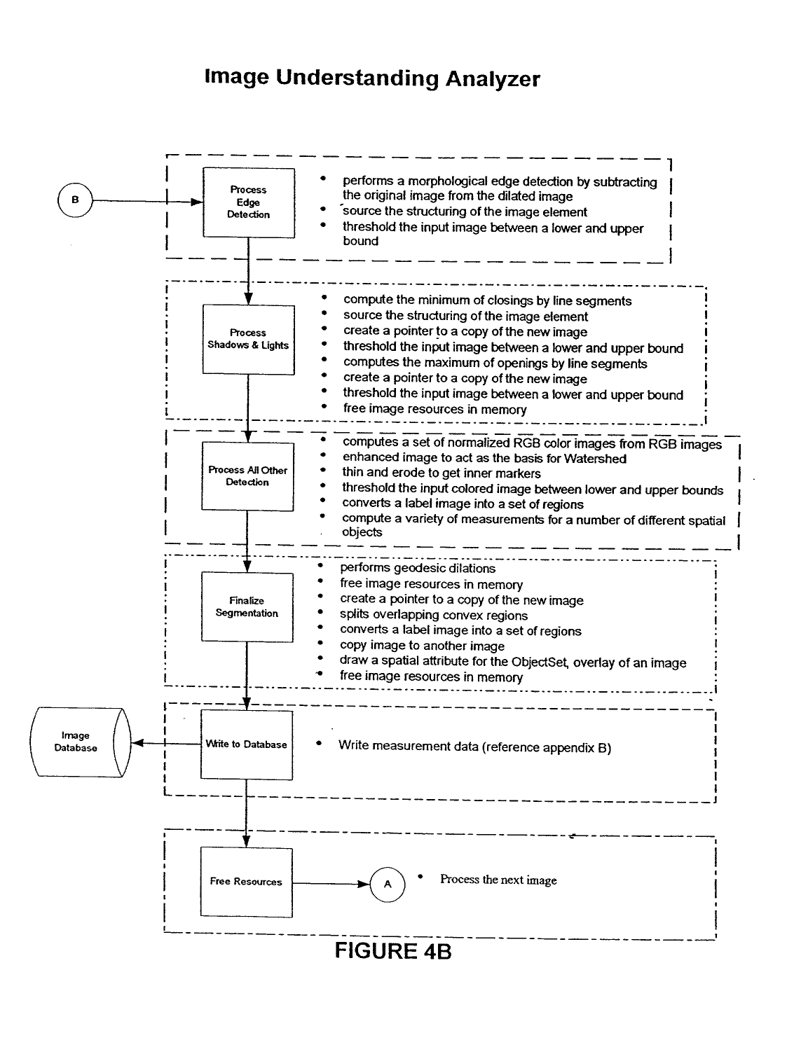

FIG. 4 shows a schematic overview of the image processing routines. The routines may included processes for detecting edges, shadows, light sources and other image variables within each image.

Behavioral Tracking

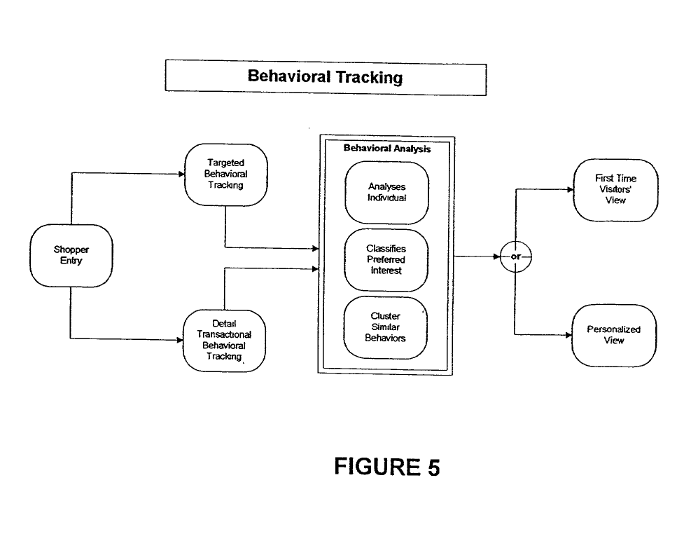

FIG. 5 illustrates a high-level overview of the behavioral tracking component. In order to activate the behavioral tracking, consumers simply enter a domain. The domain, as referred to herein, may be for example, a web site, a client/server system or a stand-alone application platform. Once in this domain, the system tracks implicit (simple page browsing) and explicit (actually selecting or requesting items) behaviors, and stores targeted behavioral data into a relational database. All behavioral activities are logged or recorded in a sequential log (i.e. an append file). The system separates the two tracking methods to assure faster real-time prediction yet keeping a complete transactional log of all behavioral activities. The transactional log allows the visual preference system to mine the data for information to enhance the behaviors understanding of its consumers. Once the data are available in the system, the visual preference system performs a number of functions including:

analyzes the individual

classifies the preferred interest of that individual

clusters the individual with those other individuals having similar behaviors.

First-time consumers benefit from starting with a predictable preference based on a pre-analysis of demographic information obtained from other consumers and its popular preferences. Each consumer is uniquely tagged as an individual shopper and each visit is tagged and stored for that consumer as a unique session. This information allows the visual preference system to answer questions for each consumer such as how often does the consumer visit, what is the consumer viewing on each visit, what is the path (the browsing or shopping pattern) of viewing or buying, etc.

Browsing online for most shoppers is usually random in nature, therefore somewhat unpredictable. With no prior historic data, it's unlikely that any system can confidently state in advance what product the shopper will select without first understanding the shopper's selection, characteristic of those selections and the probability of those selections. With the invention, however, once a shopper enters the tracking domain, behavioral tracking is immediately activated. As even small amounts of data are collected, educated predictions of that individual's likes and dislikes are formed using the standard probability theory.

To illustrate the probability theory, consider the example of selecting artwork at random from an inventory of 100 items. Each time the artwork is displayed, it will be from a completely resorted inventory. This example will consider repeating the display a very large number of times to illustrate how accurate this theory can be.

An event is defined as one piece of artwork displayed from the inventory of 100 and is represented with capital letters. The event for “nature painting” is N. The event for “seascape painting” is S. The event for a “landscape painting” is L.

The probability (called P) of an event is a fraction that represents the long-term occurrence of the event. If the event is called N, then the probability of this event is given as P(N). If the display is repeated a large number of times, then the probability of an event should be the ratio of the number of times the event selected to the total number of times the display was made. Then the probability is computed by dividing the number of selected by the total number displayed. Thus, the probability of the selected event is:

$$P ( N ) = \frac{S e l e c t e d}{T o t a l}$$

This probability theory provides a way to compute the probabilities of events in our example. If the selected event we are interested in is one of a specified category of artwork, then the probability is the number of artwork categories in the inventory, divided by the total number of artwork. Thus if N is the event, then:

P(N)=4/100=0.04

This implies that 4 out of 100 items is classified as a nature painting. If S is the event, then:

P(S)=13/100=0.13

This implies that 13 out of 100 is classified as a seascape painting. If L is the event, then:

P(L)=20/100=0.20

This implies that 20 out of 100 is classified as a landscape painting. Events can be combined and changed into other events. If we keep the names above, then (N or S) stands for the event that the artwork is either a nature painting or a seascape painting. Thus:

P(N or S)=17/100=0.17

We can also consider the event (not N) where the artwork is not a nature painting. Here, the probability of such an event is given by:

P(not N)=96/100=0.96

Each individual that is to be tracked by the system undergoes a prior probability algorithm to set the baseline of interest for attributes such as color, object placement, category, type, etc. This formula is used to establish the prior probability structure of an individual enabling us to apply other algorithms to obtain a better understanding and the prediction of that individual's taste/preferences in later processes.

Once the individual's prior probability structure has been built, that individual may be identified and classified for the purpose of further understanding that individual's taste/preferences.

This allows the system to build a model of that domain of interest for predicting the group memberships (classes) of the previously unseen units (cases, data vectors, subjects, individuals), given the descriptions of the units. In order to build such a model, the system utilizes the tracked information previously collected by using random sampling techniques. This data set contain values for both the group indicator variables (class variables) and the other variables called predictor variables. Technically, any discrete variable can be regarded as a group variable; thus the techniques represented in here are applicable for predicting any discrete variable.

This Bayesian classification modeling technique uses numerous models with weighing these different models by their probabilities instead of using pure statistical results. In many predictive experiments, the Bayesian classification methods have outperformed other classification devices such as the traditional discriminate analysis, and the more recent techniques such as neural networks and decision trees.

In the following example we are interested in predicting the art style of an object such as an art piece (group variable) using other variables (predictor variables). Classifying art interest according to their art style is an arbitrary choice. In principle any other variable can be selected as the class variable.

The framework used to describe our interest domain, and to express what sort of things is frequent or probable in the interest domain. The data make some of the models look more probable than the others. We then describe how to use the knowledge about the probabilities of the different models to predict classes of new, previously unseen data vectors.

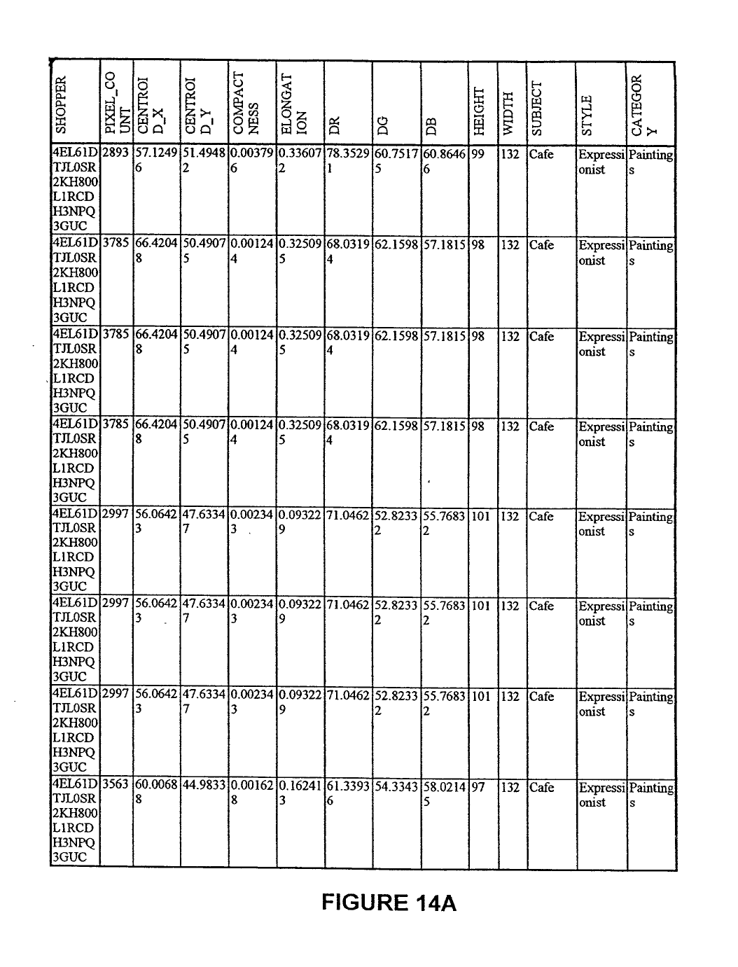

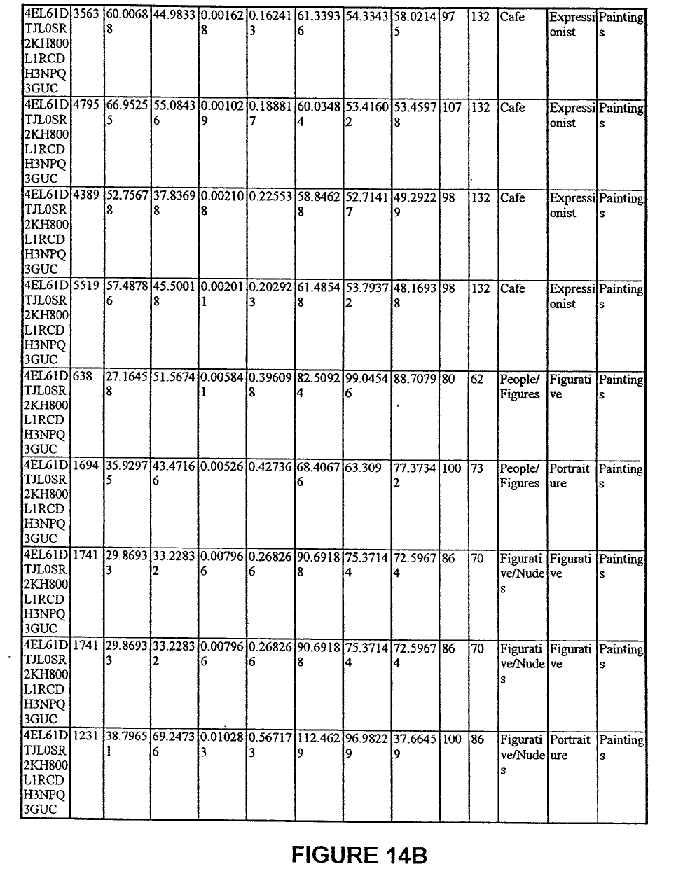

The following example demonstrates the thought and processes for building a Bayesian Classification model. The subject for this example data is of a shoppers unique visiting session on a sample web site. These simple elements were collected from behavior and quantitative images viewed while browsing through the site. The total recorded for this session was 17 events with two different artists collections within 2 different painting categories, the results of which are shown in FIG. 14. As shown in FIG. 14, the data is structured in fields to provide a set of information bout each shopper, and the images they have viewed. The definition of these fields for one embodiment of the invention is given in Table 1.

TABLE 1

| | | |
|---|---|---|
| 1. | SHOPPER: unique | 4EL61DTJL0SR2KH800L1RCDH3NPQ3 |
| | shopper ID | GUC |
| 2. | SHOPPER_SESSION: | KKGPFBCBAILCGFEJAAKNJAHK |
| | that unique shopper's one | |
| | viewing session | |
| 3. | PIXEL_COUNT: The | range 638 to 5519 |
| | number of pixels in the | |
| | region | |
| 4. | CENTROID_X: The | range 27.16458 to 66.95255 |
| | center of mass of the | |
| | region x | |
| 5. | CENTROID_Y: The | range 33.22832 to 69.24736 |
| | center of mass of the | |
| | region y | |
| 6. | COMPACTNESS: This | range 0.001029 to 0.010283 |
| | measure is 1.0 for a | |
| | perfect square | |
| 7. | ELONGATION: The | range 0.093229 to 0.567173 |
| | difference between the | |
| | lengths of the major and | |
| | minor axes of the best | |
| | ellipse fit | |
| 8. | DR: standard deviation | range 58.84628 to 112.4629 |
| | of the values of the red | |
| | band within the region | |
| 9. | DG: standard deviation | range 52.71417 to 99.04546 |
| | of the values of the green | |
| | band within the region | |
| 10. | DB: standard deviation | range 37.66459 to 88.7079 |
| | of the values of the blue | |
| | band within the region | |
| 11. | HEIGHT: The height of | 80, 86, 97, 98, 99, 100, 101, or 107 |
| | the region | |
| 12. | WIDTH: The width of | 62, 70, 73, 86, or 132 |
| | the region | |
| 13. | SUBJECT: subject of the | Café, People/Figures, or Figurative/Nudes |
| | painting | |
| 14. | STYLE: style of the | Expressionist, Figurative, or Portraiture |
| | painting | |
| 15. | CATEGORY: category | Painting or Crafts |
| | of the painting | |

As shown in Table 1, a wide variety of data can be recorded during each session. This data is then used to assist the system in predicting a shopper's preference and taste. The fields shown in Table 1 are merely representative, and not exhaustive. Other fields can be used while remaining within the spirit and scope of the invention.

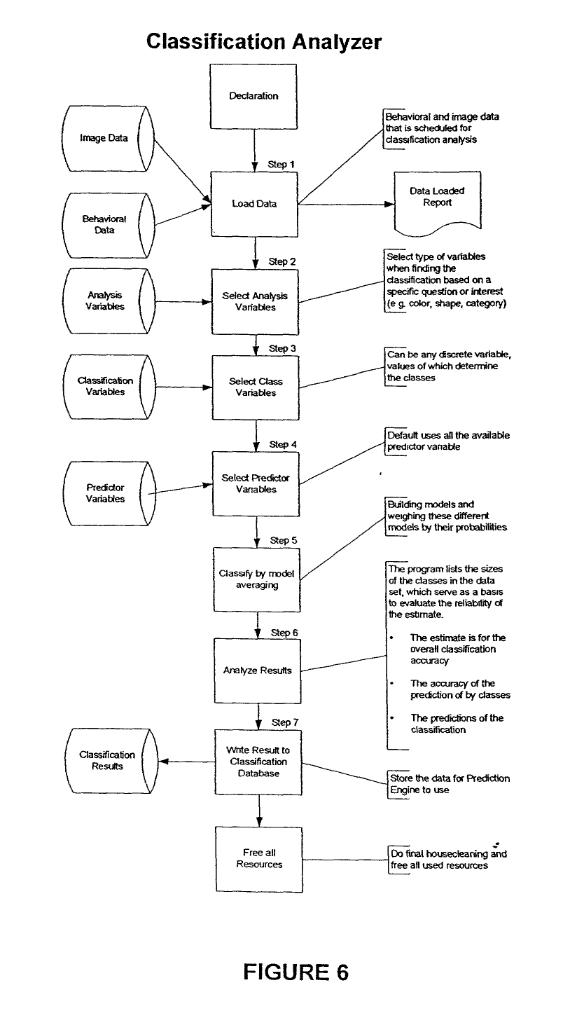

FIG. 6 illustrates the steps involved in the classification process. The visual preference system is designed to perform the Bayesian classification in the following seven steps:

Load data

Select the variables for the analysis

Select the class variable

Select the predictor variables

Classification by model averaging

Analyze the results

Store the classification results

Step 1: Load Data

The first step of the analysis is to load the data into the system. If there are any missing values, they are marked as missing (null value). The Bayesian theory handles all the unknown quantities, whether model parameters or missing data, in a consistent way—thus handling the missing data poses no problem. If we wish to handle missing values as data, all we need to do is select it as a variable for analysis and the data analysis process will act accordingly.

Step 2: Select the Variables for the Analysis

After loading the data, it may be desirable to exclude some of the variables from the analysis. For example, we might be interested in finding the classifications based on a specific object placement or color to object placement, thus we might want to exclude some of the other variables. In our example, we might want to keep only the CENTROID_X, CENTROID_Y and Color(DB, DG, DR) variables and discard the remaining variables (i.e. PIXEL_COUNT, STYLE, etc).

Step 3: Select the Class Variable

In the third step, the class variable of interest is selected. As stated earlier, this variable can be any discrete variable (i.e. color, style, category) or the values of which determine the classes.

Step 4: Select the Predictor Variables

The default choice in performing the classification is to use all the available predictor variables. However, there are two reasons why we may want to use only a subset of the predictor variables. First, selecting a subset of predictor variables usually produce better classifications. Second, restricting the set of predictor variables gives us information on the relevance of the variables (or more generally, the subsets of variables) for the classification.

We can either construct a subset of predictor variables from prior information by picking them one-by-one as long as it is estimated to be beneficial to the classification. Or we may choice to construct a subset using all of the predictor variables and then cut back the variables set by leaving out variables one-by-one as long as it is estimated to be beneficial for the classification. The estimate of benefit of a class is based on prior classification training set results.

Step 5: Classification by Model Averaging

To best illustrate the Bayesian algorithm for classification, let's assume we have a model represented by the letter M. We use this model to classify a variable artq, when we know all values of the predictor variables of artq, but not based on artwork style like expressionist or figurative. Trying to place the artq into different classes and picking the most probable attempt can now utilize this feature. Let's denote artqexpressionist to be the art that is otherwise like artq, but has its art style set to be expressionist. Similarly, we denote artqfigurative to be the art that is otherwise like artq, but is figurative. So we have the alternatives artqexpressionist and artqfigurative. Since we know everything about these art pieces, they can be assigned a probability by the model M using the formula below and determining whether it is more probable for artq to be an expressionist or a figurative piece. Stating this mathematically, we have to determine which of the two probabilities P(artqexpressionist|M) and P(artqfigurative|M) is the greater.

Before seeing any data, we select parameters according to our prior probability or prior beliefs discussed above (i.e. in this example P(Style=Expressionist |M)=½). After observing some data, a number of possibilities appears more plausible than the others. The trustworthiness of the model is taken into account by letting the probability of the model determine how much the model is used in classification. Again, if M1 is twice as probable as M0.5, M1 should be used twice as much as M0.5. Mathematically speaking, the system weighs the models by their probabilities. Let's consider what happens to our prediction if we decided to use models M0.65, M0.3 and M0.2 instead of M1 alone.

M1 is categorically saying that artq is expressionist. Now, we try the models M0.65, M0.3, M0.2. We start by looking at the probabilities of the models. We notice that the probability of the M0.3 is 0.3 times the probability of M1. In general, if we denote the probability of the M1 by C (the probability of the model M1),we get the following results:

| | |
|---|---|
| P(M1\|art1) = | 1.0 × C |
| P(M0.65\|art1) = | 0.65 × C |
| P(M0.3\|art1) = | 0.3 × C |
| P(M0.2\|art1) = | 0.2 × C |

Now Weighing the Predictions by These Probabilities we Get:

$$P ( artqfigurative \vert M0 .65 , M0 .3 , M0 .2 ) = P ( M0 .65 \vert art1 ) \times P ( artqfigurative \vert M0 .65 ) + P ( M0 .03 \vert art1 ) \times P ( artqfigurative \vert M0 .03 ) + P ( M0 .02 \vert art1 ) \times P ( artqfigurative \vert M0 .02 ) = 0.65 \times P ( artqfigurative \vert M0 .65 ) + 0.3 \times P ( artqfigurative \vert M0 .03 ) + 0.2 \times P ( artqfigurative \vert M0 .02 ) = 0.65 \times 0.65 + 0.3 \times 0.3 + 0.2 \times 0.2 = ( 0.65 \times 0.65 + 0.3 \times 0.3 + 0.2 \times 0.2 ) = ( 0.4225 + 0.009 + 0.04 ) = 0.5525 and P ( artqexpressionist \vert M0 .65 , M0 .3 , M0 .2 ) = P ( M0 .65 \vert art1 ) \times P ( artqexpressionist \vert M0 .65 ) + P ( M0 .03 \vert art1 ) \times P ( artqexpressionist \vert M0 .03 ) + P ( M0 .02 \vert art1 ) \times P ( artqexpressionist \vert M0 .02 ) = 0.65 \times P ( artqexpressionist \vert M0 .65 ) + 0.3 \times P ( artqexpressionist \vert M0 .03 ) + 0.2 \times P ( artqexpressionist \vert M0 .02 ) = 0.65 \times 0.35 + 0.3 \times 0.7 + 0.2 \times 0.8 = ( 0.65 \times 0.35 + 0.3 \times 0.7 + 0.2 \times 0.8 ) = ( 0.2275 + 0.21 + 0.16 ) = 0.5975$$

Since P(artqfigurative|M0.65, M0.3, M0.2) and P(artqexpressionist|M0.65, M0.3, M0.2) must sum up to a value of one we get:

$$P ( artqfigurative \vert M0 .65 , M0 .3 , M0 .2 ) = \frac{0.5525 \times C}{0.5525 \times C + 0.5975 \times C} \approx 0.48$$

$$and$$

$$P ( artqexpressionist \vert M0 .65 , M0 .3 , M0 .2 ) = \frac{0.5975 \times C}{0.5525 \times C + 0.5975 \times C} \approx 0.52$$

Whatever the value for C (probability of the model M1) using the models M0.65, M0.3 and M0.2 and weighing them by their probabilities, we find that it is somewhat more probable that artq is expressionist rather than figurative.

Step 6: Analyze the Results

Periodically the results of the classification process are analyzed in order to check for accuracy and to further fine-tune the processes for selecting the classes and predictor variables. The results of this classification analysis are represented at three levels of details:

The estimate of the overall classification accuracy

The accuracy of the prediction by class

The predictions of the classification

A method is used that allows one variable at a time to be kept away from the process that builds its classifier using all but a testing variable (for example, color). The classifier tries then to classify this “testing” variable, and its performance is measured. This way the classifier faces the task every time it has to classify a previously unseen variable. Consequently, a fair estimate of the prediction capabilities of the classifier from this process can be determined. Classification result is compared with the percentage available by classifying every variable to the majority class.

Step 7: Store the Classification Results

The measurements and labels of the classification results are stored in a relational database to be further used in the prediction engine.

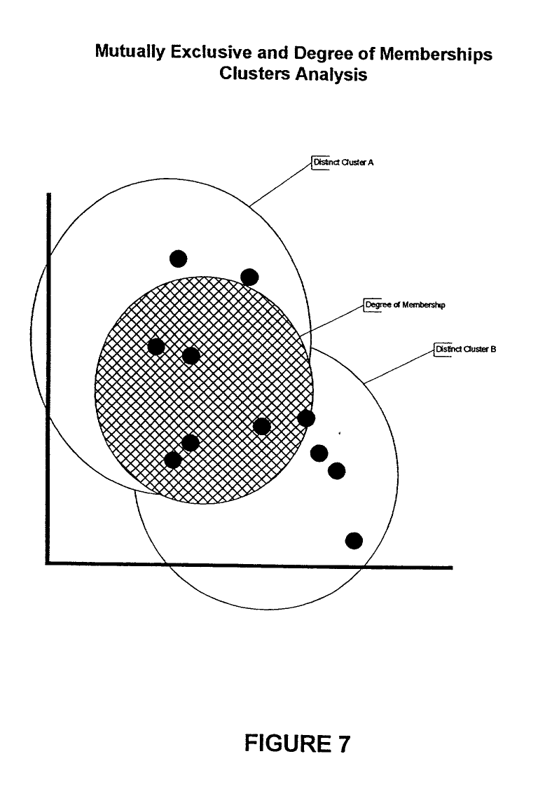

The next step in the process is to cluster the individuals with those of others having similar behaviors. FIG. 7 illustrates schematically this process. Cluster analysis identifies individuals or variables on the basis of the similarity of characteristics they possess. It seeks to minimize within-group variance and maximize between-group variance. The result of cluster analysis is a number of heterogeneous groups with homogeneous contents: There are substantial differences between the groups, but the individuals within a single group are similar (i.e. style, category, color).

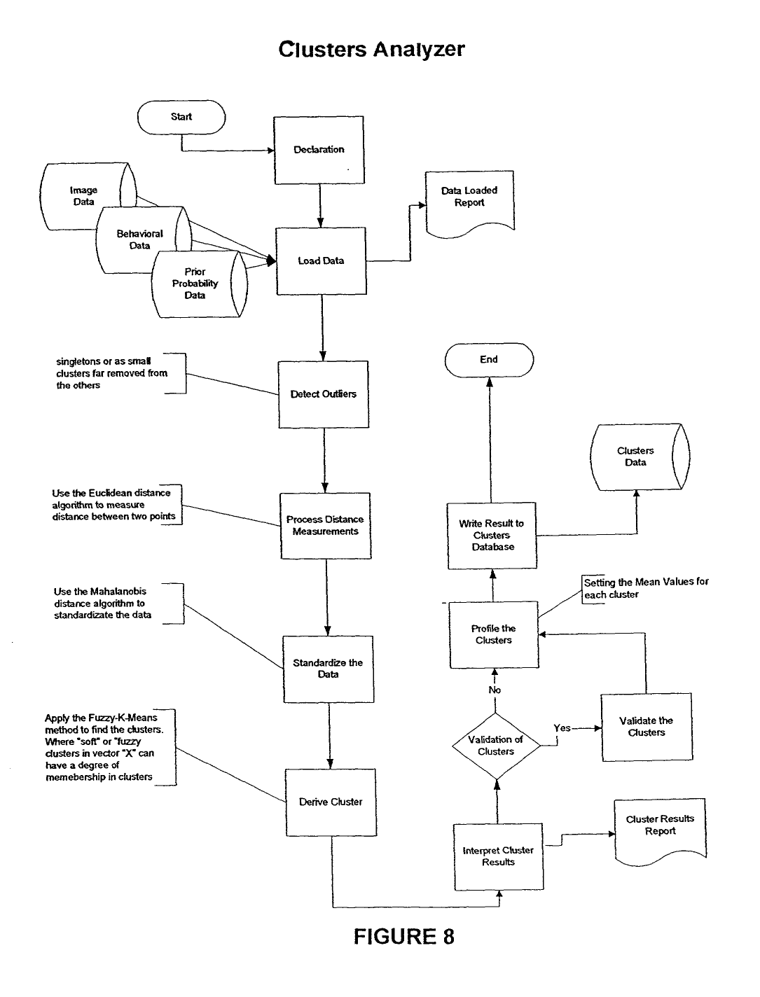

The data for cluster analysis may be any of a number of types (numerical, categorical, or a combination of both). Cluster analysis partitions a set of observations into mutually exclusive groupings or degree of memberships to best describe distinct sets of observations within the data. Data may be thought of as points in a space where the axes correspond to the variables. Cluster analysis divides the space into regions characteristic of groups that it finds in the data. The steps involved are shown in FIG. 8, and include the following:

Prepare the data

Derive clusters

Interpret clusters

Validate clusters

Profile clusters

Step 1: Preparing the Data

A first step in preparing the data is the detecting of outliers. Outliers emerge as singletons within the data or as small clusters far removed from the others. To do outlier detection at the same time as clustering the main body of the data, the system uses enough clusters data to represent both the main body of the data and the outliers.

The next substep in the data preformation phase is to process distance measurements. The Euclidean distance measurement formula is used for variables that are uncorrelated and have equal variances. The statistical distance measurement formula is used to adjust for correlations and different variances. Euclidean distance is the length of the hypotenuse of a right triangle formed between the points. In a plane with p1 at (x1, y1) and p2 at (x2, y2), it is ((x1−x2)²+(y1−y2)²)).

The data are then standardized if necessary. If standardization of the data is needed; the statistical distance (Mahalanobis distance formula-Dˆ 2=(x−μ)′Σˆ {−1}(x−μ)) is used. Standardization of the data is needed if the range or scale of one variable is much larger or different from the range of others. This distance also compensates for inter-correlation among the variables. One may sum across the within-groups and sum-of-products matrices to obtain a pooled covariance matrix for use in statistical distance.

Step 2: Deriving Clusters

Clustering algorithms are used to generate clusters of users and objects. Each cluster has a seed point and all objects within a prescribed distance are included in that cluster. In one embodiment three nonhierarchical clustering approaches are used to derive the best clustering results:

1) sequential threshold-based on one cluster seed at a time and membership in that cluster fulfilled before another seed is selected, (i.e., looping through all n points before updating the seeds. The clusters produced by standard means such as the k-means procedure are sometimes called “hard” or“crisp” clusters, since any feature vector x either is or is not a member of a particular cluster. This is in contrast to “soft” or “fuzzy” clusters used herein, in which a feature vector x can have a degree of membership in each cluster (the degree of membership can also be interpreted probabilistically as the square root of the a posteriori probability that the x is in Cluster i). The fuzzy-k-means procedure allows each feature vector x to have a degree of membership in Cluster i. To perform the procedure the system makes initial guesses for the means m1, m2, . . . , mk. The estimated means are used to find the degree of membership u(j,i) of xj in Cluster i, until there is no changes in any of the means. For example, if a (j,i)=exp(−∥xj−mi∥2), one might use u(j,i)=a(j,i)/sum₁₃j a(j,i), and then for i from 1 to k, replace mi with the fuzzy mean of all of the examples for Cluster i. The process is continued until it converges.

$${m}_{i} = \frac{{\sum }_{j} {u ( j , i )}^{2} {x}_{j}}{{\sum }_{j} {u ( j , i )}^{2}}$$

2) parallel threshold-based on simultaneous cluster seed selection and membership threshold distance adjusted to include more or fewer objects in the clusters, (i.e., updating the seeds as you go along)

3) optimizing-same as the others except it allows for reassignment of objects to another cluster based on some optimizing criterion.

To select a seed point, one method is to let k denote the number of clusters to be formed (usually based on prior clustering seed point). The value of k is then fixed as needed and k seed points are chosen to get started. The results are dependent upon the seed points, so clustering is done several times, starting with different seed points. The k initial seeds can arbitrarily be, for example:

the first k cases

a randomly chosen k cases

k specified cases (prior)

or chosen from a k-cluster hierarchically

To determine the acceptable number of clusters practical results and the inter-cluster distances at each successive steps of the clustering process help guide this decision. In one embodiment the formula used in the model selection criteria is to use the BIC (Bayesian Information Criterion) to estimate k, wherein the BIC=−2 log likelihood+log(n)*number of parameters.

Step 3: Interpretation of the Clusters

This is a creative process. Examination of the cluster profiles provides an insight as to what the clusters mean. Once understanding it's meaning, parameters are set as prior or predefined cluster criteria in the system.

Step 4: Validating the Clusters

Validation is threefold, including the use of statistical, test case validity, and variable validity.

Statistical Tests—The mean vector and covariance matrix of the testing sample is compiled. Pseudorandom samples of n1, n2 and n3 are drawn from the corresponding multinormal distribution and a measure of spread of the clusters computed. Then a sampling distribution for the measure of spread is generated. If the value for the actual sample is among the highest, it may be concluded as statistical significance.

Validity in Test Cases—The testing is split into training and test cases. The centroids from the clustering of the training cases is be used to cluster the test cases to see if comparable results are obtained.

Validity for Variables not Used in the Clustering—The profile of the clusters across related variables not used in the clustering is used in assessing validity.

Step 5: Profiling of the Clusters

A “profile” of a cluster is merely the set of mean values for that cluster. Once the cluster is formed, extracted and stored it is later used as valuable profiling data to help predict the consumer's taste/preferences.

Prediction Engine

The visual preference system prediction engine component uses individual and collective consumer behavior and quantitative image data to define the structure of its belief network. Relationship between variables are stored as prior and conditional probabilities; based on initial training and experience with previous cases. Over time, using statistics from previous and new cases, the prediction engine can accurately predict product(s) consumers would most likely desire.

Each new consumer provides a new case (also referred to as “evidence”) which constitutes a set of findings that go together to provide information on one object, event, history, person, or thing. The prediction engine finds the optimal products for the consumer, given the observable variable and values tracked and processed which includes information derived from the behavioral and image analyzer systems. The goal is to analyze the consumer by finding beliefs, for the immeasurable “taste/preference” variables and to predict what consumers would like to see.

For the most part, online browsing for a good number of consumers is usually random in nature, and arguably unpredictable. With no prior historic data, it is unlikely any system can confidently predict what products the consumer will select without first understanding the consumer's selection and characteristic of those selections along with the probability of those selections. The visual preference system's prediction engine has developed the next wave of recommendation and personalization technology that addresses uncertain knowledge and reasoning which targets the specific area of predicting customer's taste, referred to as taste-based technology. The predictive features of the visual preference system's technology are based on belief networks with fundamental principal of logic known as Bayes' theorem. Properly understood and applied, the theorem is the fundamental mathematical law governing the process of logical inference, based on the body of evidence available and determining what degree of confidence/belief we may have in various possible conclusions. The incorporation of this predictive reasoning theorem in conjunction with the behavioral and image analysis components permits the visual preference system to have the most advanced taste-based technology available.

Taken together, the image analyzer, behavior tracking, and prediction engine make up the visual preference system's state-of-the-art technology. The following is an explanation of the belief network and how the visual preference system technology utilizes it to predict a person's personal taste.

A belief network (also known as a Bayesian network or probabilistic causal network) captures believed relations (which may be uncertain, stochastic, or imprecise) between a set of variables that are relevant in solving problems or answering specific questions about a particular domain.

The predictive features of a belief network are based on a fundamental principal of logic known as Bayes' Theorem. Bayes' Theorem is used to revise the probability of a particular event happening based on the fact that some other event had already happened. Its formula gives the probability P(AIB) in terms of a number of other probabilities including P(BIA). In its simplest form, Bayes' formula says,

$$P ( A \vert B ) = \frac{P ( B \vert A ) P ( A )}{P ( B \vert A ) P ( A ) + P ( B \vert n o t A ) P ( n o t A )}$$

Classic examples of belief networks occur in the medical field. In this domain, each new patient typically corresponds to a new “case” and the problem is to diagnose the patient (i.e. find beliefs for the immeasurable disease variables), predict what is going to happen to the patient, or find an optimal prescription, given the values of observable variables (symptoms). A doctor may be the expert used to define the structure of the network, and provide the initial relations between variables (often in the form of conditional probabilities), based on his medical training and experience with previous cases. Then the network probabilities may be fine-tuned by using statistics from previous cases and from new cases as they arrive.

When a belief network is constructed, one node is used for each scalar variable. The words “node” and “variable” are used interchangeably throughout this document, but “variable” usually refers to the real world or the original problem, while “node” usually refers to its representation within the belief network.

The nodes are then connected up with directed links. If there is a link from node A to node B, then node A is called the parent, and node B the child (B could be the parent of another node). Usually a link from node A to node B indicates that A causes B, that A partially causes or predisposes B, that B is an imperfect observation of A, that A and B are functionally related, or that A and B are statistically correlated.

Finally, probabilistic relations are provided for each node, which express the probabilities of that node taking on each of its values, conditioned on the values of its parent nodes. Some nodes may have a deterministic relation, which means that the value of the node is given as a direct function of the parent node values.

After the belief network is constructed, it may be applied to a particular case. For each known variable value, we insert the value into its node as a finding. Then our prediction engine performs the process for probabilistic inference to find beliefs for all the other variables. Suppose one of the nodes corresponds to the art style variable, herein denoted as “Style”, and it can take on the values Expressionist, Figurative and Portraiture. Then an example belief for art could be: [Expressionist-0.661, Figurative-0.188, Portraiture-0.151], indicating the subjective probabilities that the artwork is Expressionist, Figurative or Portraiture.

Depending on the structure of the network, and which nodes receive findings or display beliefs, our prediction engine predicts the probabilistic of a particular taste/preference characteristics (i.e. style, color, object placement, etc). The final beliefs are called “posterior” probabilities, with “prior” probabilities being the probabilities before any findings were entered. The prior probability data were derived earlier in our “Behavior tracking” system and now is used as the baseline probability to help derive the “posterior” probabilities of the domain interest.

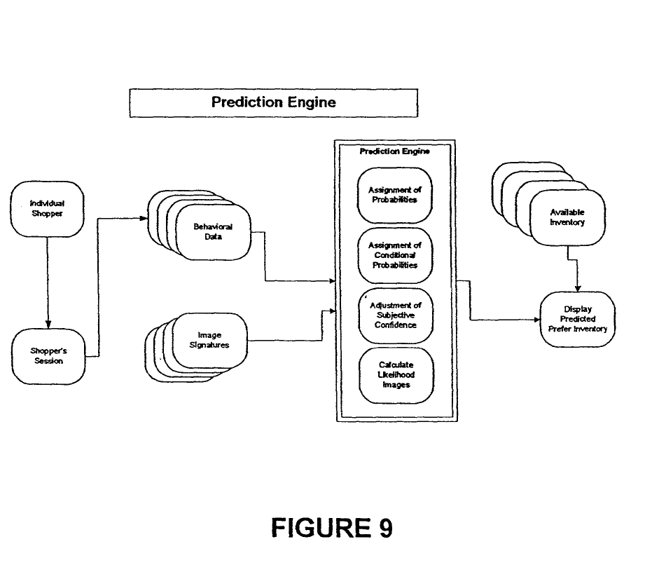

FIG. 9 illustrates a high-level overview of the prediction system in accordance with an embodiment of the invention. The main goal of the prediction engine (probabilistic inference) system is to determine the posterior probability distribution of variables of interest (i.e. prefer color, object placement, subject, style, etc.) given some evidence (image attributes viewed) for the purpose of predicting products that the customer would like (i.e. art, clothing, jewelry, etc.). The visual preference system prediction engine system is designed to perform two major prediction functions:

Prediction if posterior probability data are already available

Prediction if posterior probability data need to be derived.

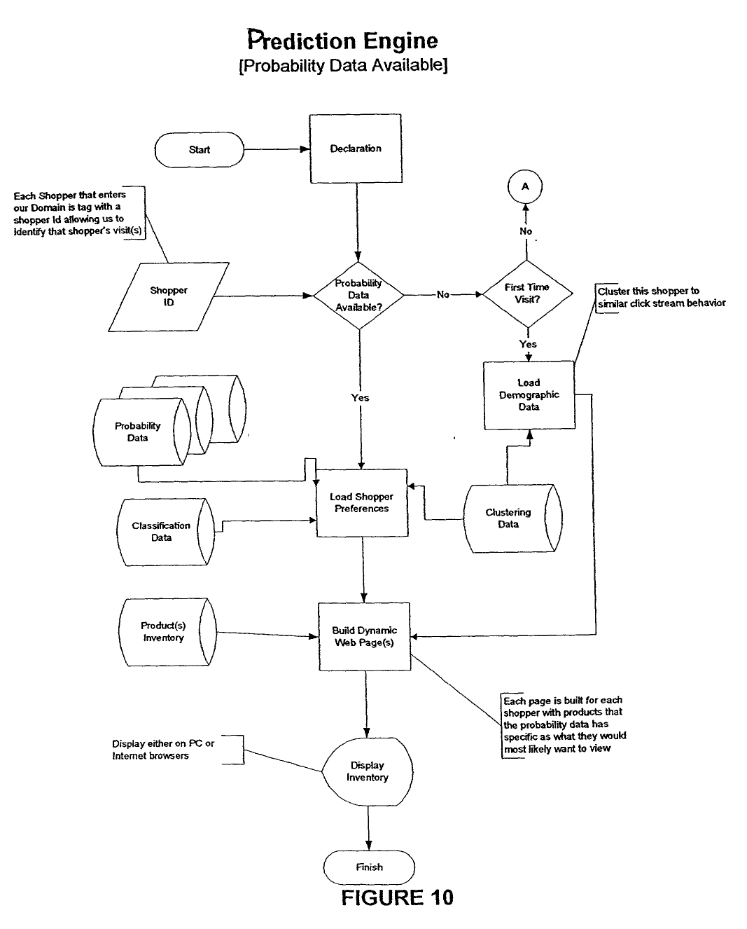

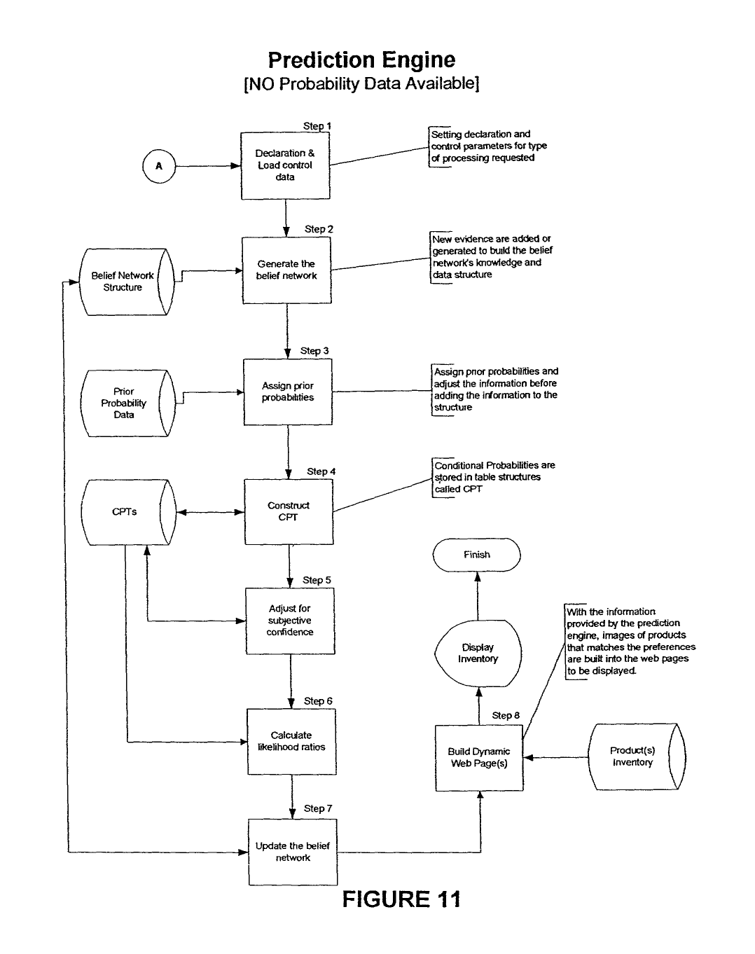

FIGS. 10 and 11 illustrate mechanisms for each function. A first step is to evaluate if posterior probability is available. If posterior probability is available then the method proceeds as shown in FIG. 10. Probability data is firest read into the system. Each shopper that enters is tagged iwth a shopper id allowing the system to identify that shopper's visits. Dynamic pages are generated for each shopper with products that the probability data has specified that particular shopper would most likely want to see. The system then displays the relevant product or products.

If the posterior probability is not available the following eight steps, shown in FIG. 11, are executed:

Step 1: Load Data

The first step is to load the image, behavioral, prior probability data into the system. Loading the data equates to making the data available to the system and access all or portion of the required information, which includes system control parameters.

Step 2: Generate a Belief Network Structure

This is a three-step process, including:

1 . The system retrieves the set of variables that represent the domain of interest.

2. The order for the variables is set-i.e., in one embodiment root interests are chosen first, followed by variables in order of dependence.

3. While there are variables left to process the system continues to:

1. Pick a variable and add a node for it, and

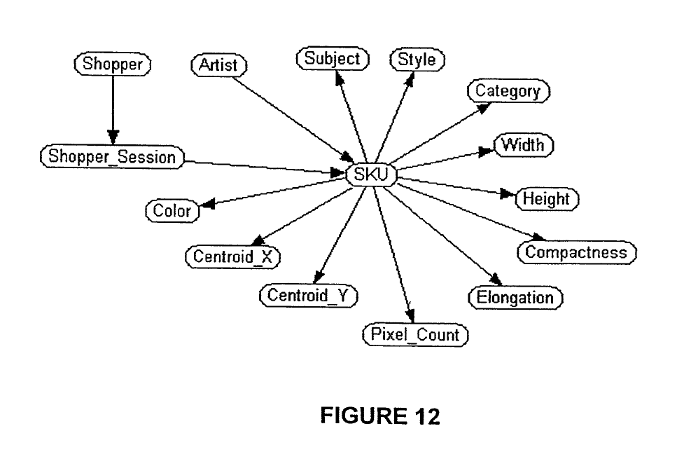

2. Set the parents of X to a minimal set of nodes already in the network and ensure each parent node has a direct influence on its child. An example of such a tree is shown in FIG. 12.

Step 3: Assign Prior Probabilities to Structure

In the behavior tracking system, standard prior probability data were already computed and stored. In order to use this prior probability distribution for a prediction process, it must be transformed into a set of frequencies. It's necessary to find the confidence level of the data being worked with and assign the best prior probabilities to the belief network structure.

For example, the distribution (0.5 0.5) could be the result of the observation of 5 blue and 5 red or 500 blue and 500 red. I n both cases, the distribution would be (0.5 0.5) but the confidence in the estimate would be higher in the second case than in the first. The difference between the two examples is the size of the transactional data that the prior distributions are built. If it can be assumed that the the prior distributions are built upon 2 cases, 200 blues and 800 reds, the estimate for the prior probability is:

P(color=blue)=((0.5×2)+200)/(2+(200+800)) =0.2

P(color =red)=((0.5×2)+800)/(2+(200+800)) =0.8

Step 4: Construct the Conditional Probabilities Tables (CPT)

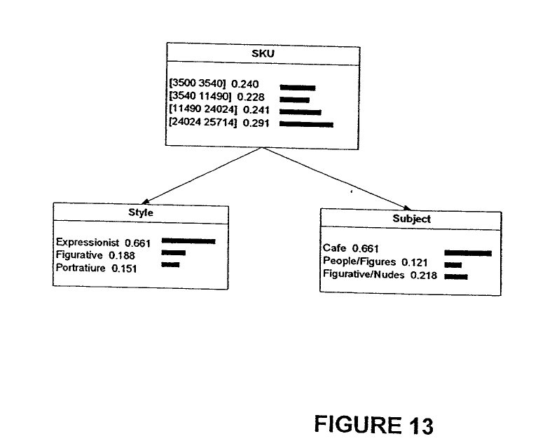

FIG. 13 illustrates an example of the CPT structure. CPT is an abbreviation for conditional probability table (also known as “link matrix”), which is the contingency table of conditional probabilities stored at each node, containing the probabilities of the node given each configuration of parent values.

The type of relationship between the parents and a child node will affect the amount of time that is required to fill in the CPT. Since most of the relationships are uncertain in nature, the system employs the noisy-OR relation model to rapidity build the conditional probabilities. The noisy-OR model has 3 assumptions:

Each characteristics has an independent chance of causing the effect

All possible characteristics are listed

Effect inhibitors are independent

For example, suppose we are interested in the likelihood of having a piece of art that is described as figurative. We determine some characteristic of a figurative and assume that we have listed all possible characteristics, as per point#2 above. We also assume that each cause has an independent chance of describing a characteristic (#1). Finally, we assume that the factors that inhibit one characteristic from causing an artwork to be figurative are independent from the factors that inhibit another artwork from causing an artwork (#3).

Suppose Further That we Know the Following:

P(artwork|figurative)=0.4

P(artwork|expressionist)=0.8

P(artwork |portraiture)=0.9

We then calculate the noise parameter for each cause as 1 - (chance of causing a figurative). In other words, the noise parameter for P(artwork|figurative) is 0.6, while the other two are 0.2 and 0.1 respectively. To fill out the CPT, the system calculates P(˜artwork) for each conditioning case by multiplying the relevant noise parameters.

Step 5: Adjust for Subjective Confidence

Up to this point, the “probability” has been defined as the relative frequency of events but to get the best possible probability for any variable, we need to accurately adjust the “probability” for subjective confidence.

The subjective confidence is the truth of some particular hypothesis that has been computationally adjusted upward or downward in accordance with whether an observed outcome is confirmed or unconfirmed. Prior hypothesis data are used as the standard to judge the confirmed or unconfirmed conditions.

For example, suppose we are 75% confident that hypothesis A is true and 25% confident that it is not true. Subjective confidence is described as “scP”. The corresponding subjective probabilities could be constructed as

scP(A)=0.75 and scP(˜A)=0.25

Suppose also we believe event B to have a 90% chance of occurring if the hypothesis is true (B|A), but only a 50/50 chance of occurring if the hypothesis is false (B|˜A). Thus:

ScP(B|A)=0.9

scP(˜B|A)=0.1

scP(B|˜A)=0.5 and

scP(˜B|˜A)=0.5

Where A=hypothesis A is true; ˜A=hypothesis A is false; B=event B occurs; ˜B=event B does not occur.

The resulting subjective probability values cause the system to adjust the degree of subjective confidence in hypothesis A upward, from 0.75 to 0.844, if the outcome is confirmatory (event B occurs), and downward, from 0.75 to 0.375, if the outcome is unconfirmed (event B does not occur). Similarly, the degree of subjective confidence that hypothesis A is false would be adjusted downward, from 0.25 to 0.156, if event B does occur, and upward, from 0.25 to 0.625 if event B does not occur.

Step 6: Calculate Likelihood Ratios

In order to apply the above findings we need to calculate the likelihood probabilities P(E|H,I) of the evidence under each hypothesis and the prior probabilities P(H|I) of the hypothesis independent of the evidence. The likelihood comes from knowledge about the domain. The posterior probability P(H|E,I) is described as the probability of the hypothesis H after considering the effect of evidence E in context I.

The system then calculates the Likelihood Ratios as follows:

1. define the prior odds

2. get the posterior odds, which are related to conditional probabilities

3. consider how adequate the evidence is for concluding hypothesis

4. using odds and likelihood ratio definitions, get the posterior probability

5. Given the assumptions of conditional independence where cases that have more than one bit of evidence. We multiply together the levels of sufficiency for each bit of evidence, multiply the result by the prior odds, and we have the posterior odds for the variable given all the evidence.

Mathematically, Bayes' Rule States:

$$posterior probability = \frac{conditional likelihood * prior}{likelihood}$$

To consider a simple calculation example, what is value of PR(B|A)? [B given A]. The a priori probability of Elongation B is 0.0001. The conditional probability of an Figurative A given a Elongation is PR(A|B).

| | Elongation | Color |
|---|---|---|
| Figurative | 0.95 | 0.01 |
| No Figurative | 0.05 | 0.99 |

$$P R ( B \vert A ) = \frac{o d d s ( B \vert A )}{1 + o d d s ( B \vert A )}$$

$$\begin{matrix}o d d s ( B \vert A ) = L i k e l i h o o d ( A \vert B ) * o d d s ( B ) = \\ = \frac{P R ( A \vert B )}{P R ( A \vert {B}^{′} )} * \frac{P R ( B )}{P R ( {B}^{′} )} \\ = \frac{0.95}{0.01} * \frac{0.0001}{0.9999} \\ = 0.0095\end{matrix}$$

Thus PR(B|A) 0.00941—is 94 times more likely than a priori.

Step 7: Updating the Belief Network Structure

The process of updating a belief network is to incorporate evidence one piece at time, modifying the previously held belief in the unknown variables constructing a more perfect belief network structure with each new piece of evidence.

Step 8: Use Belief Network to Predict the Preferred Product(s)

The built belief network data structure is used to predict preferences of an individual or clustered group by selecting the highest probability of similar characteristics from their past and current attribute of interest. A subset of qualify inventory are then selected to be displayed to the visitor that fits within the most likely product(s) predicted for that individual.

Web Site Embodiment

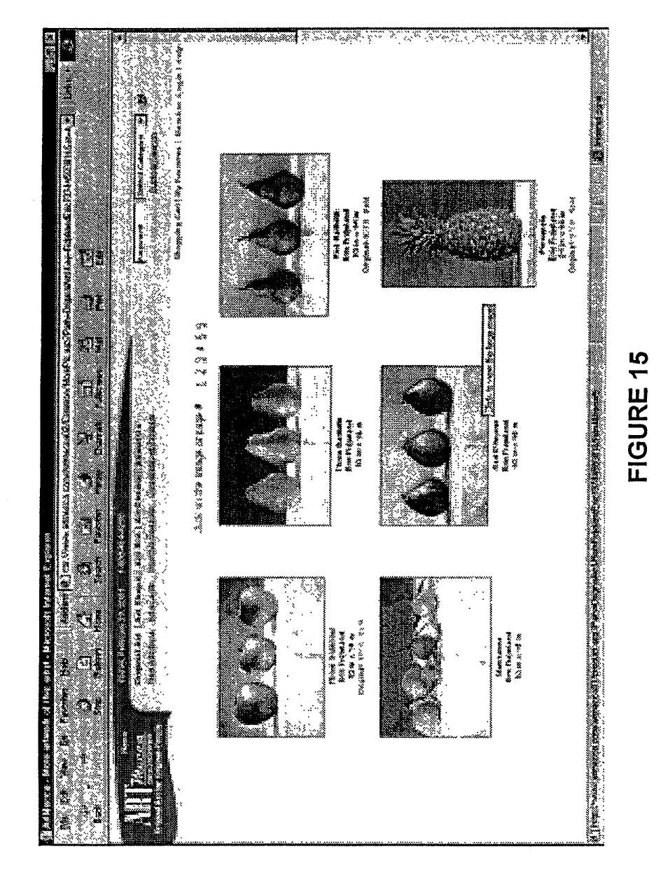

The invention is particularly well-suited to application in an on-line environment. FIGS. 15 through 26 illustrate an embodiment of the invention applied to a consumer shopping site on the Web. This illustrates the process of the visual preference system, and particularly the prediction engine compent's art selections.

As shown in FIG. 15 the web site presents an artist artwork for the viewer to view. If the viewer is interested in one of the artwork, he/she will click that image to view a larger image and to get more detail information about that artwork. With each click, the system is able to keep track of the images shown that each individual visitor.

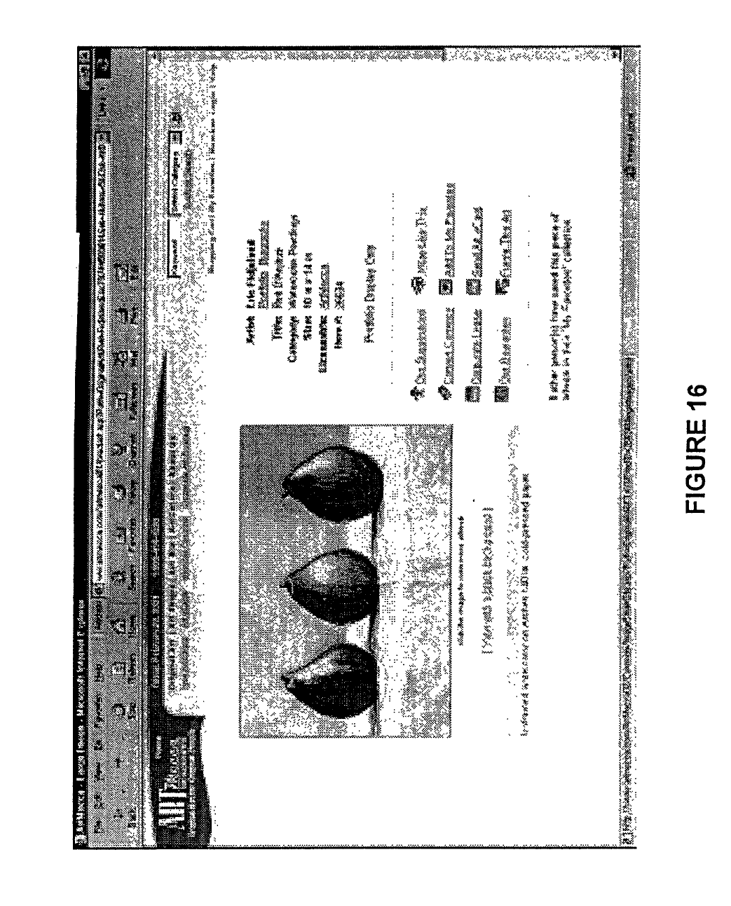

Once viewing the large image, shown in FIG. 16, the viewer has an option to request for more images like the one that he/she is viewing. The system knows the quantitative value of the current image, plus is able to extract the probability of images that are in the inventory that would have the characteristic that would interest that viewer.

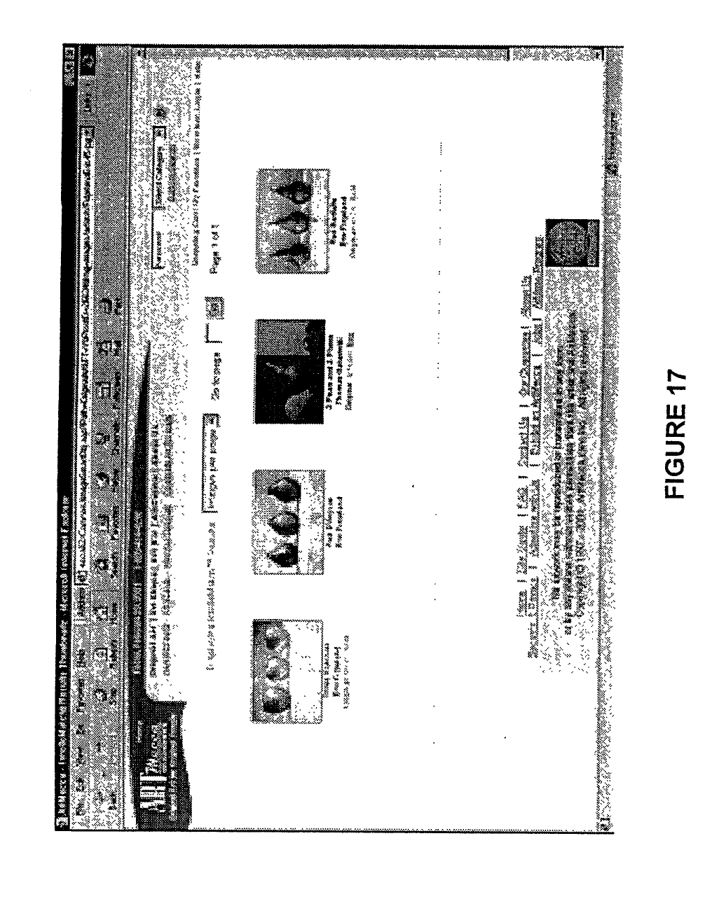

Due to the result of the prediction engine's findings, the resulting display page is dynamically constructed to present to the viewer, as shown in FIG. 17.

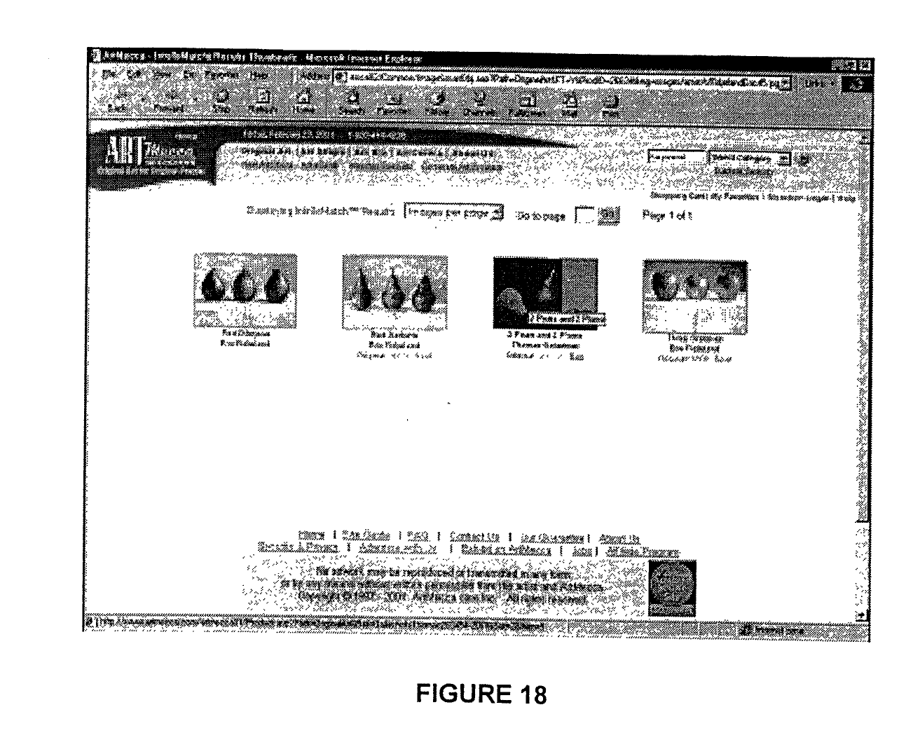

Once again the viewer may choice to click another image of interest, chosen from the list in FIG. 18.

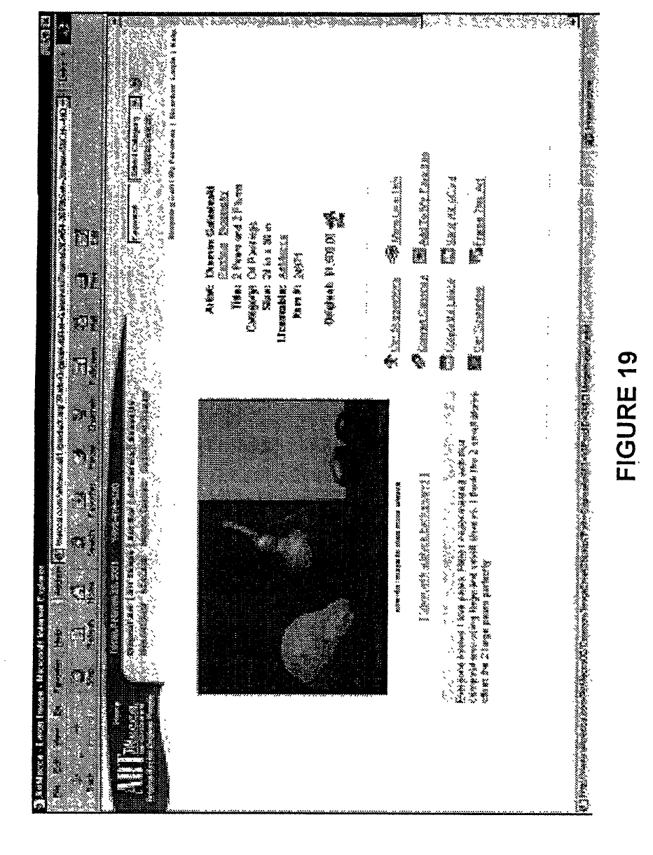

Once again on the large image page, shown in FIG. 19, the viewer can again select the option of getting more images like the one he/she is viewing.

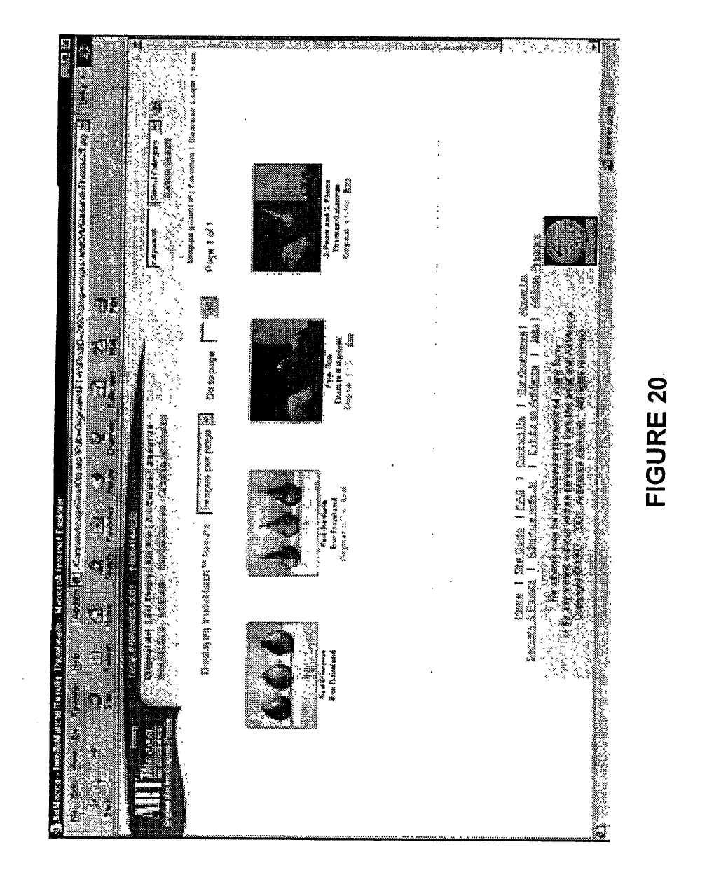

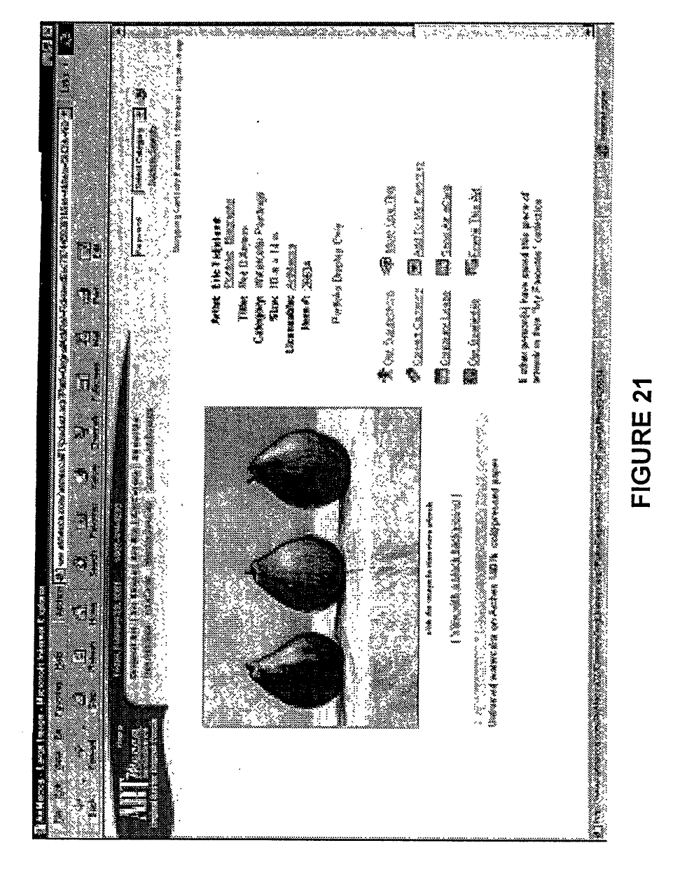

Once again the prediction engine retrieves the artwork available in the inventory that would most likely be what the viewer is wanting. This prediction engine uses images already viewed, behavioral pattern (i.e. artwork category, path of click stream, etc.) and the quantitative value of the current image, in order to generate the new list of images based on the users preferences, and displays them as shown in FIG. 20.

Another option available to the viewer is the “Our Suggestion” option, shown in FIG. 21. With this option the system will predict artwork that the viewer may like and display artwork that may or may not all be in the same art category.

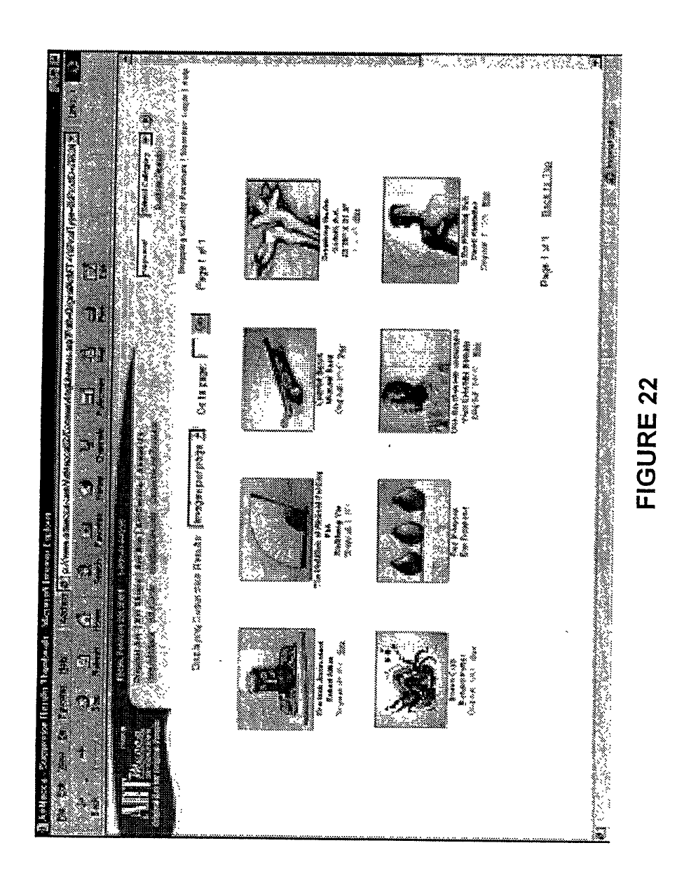

As a result of the prediction engine's findings, the resulting display page is dynamically constructed to present to the viewer, shown in FIG. 22.

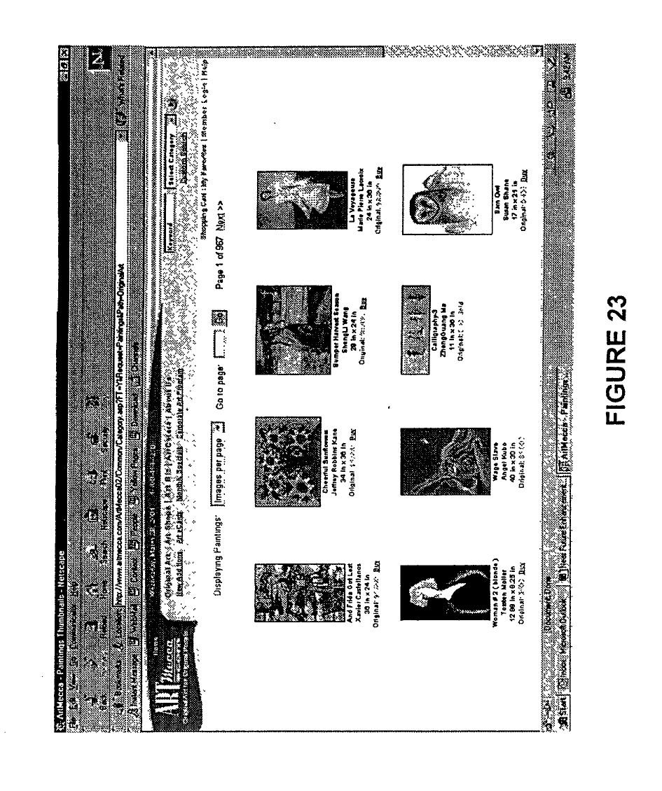

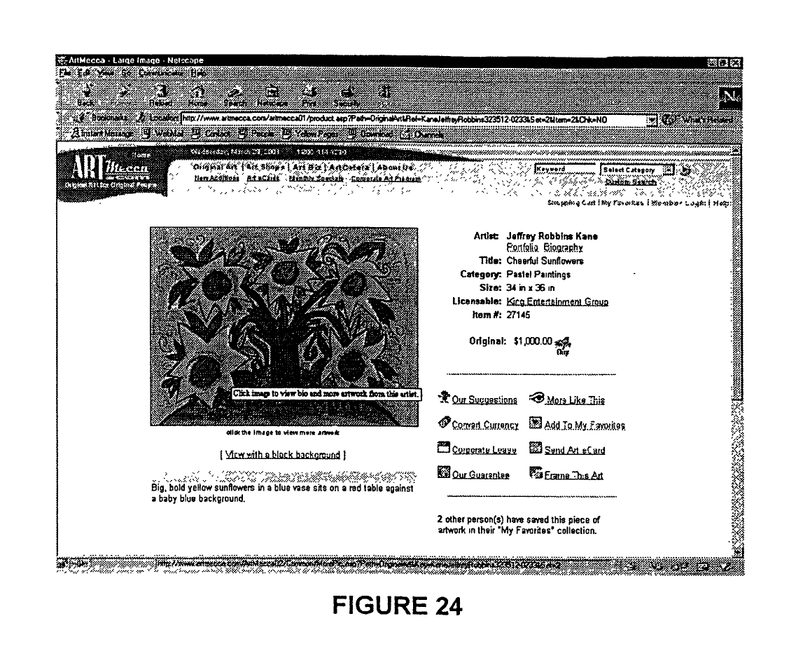

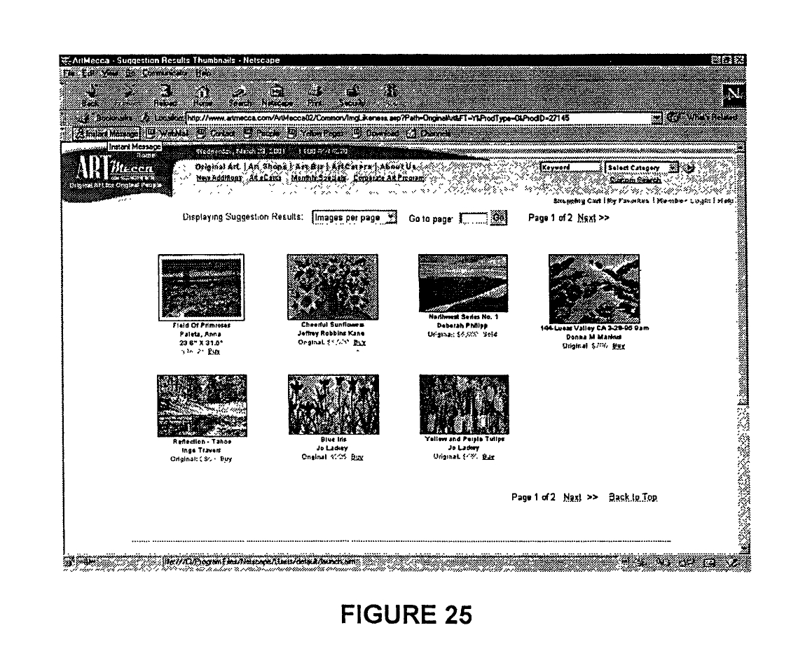

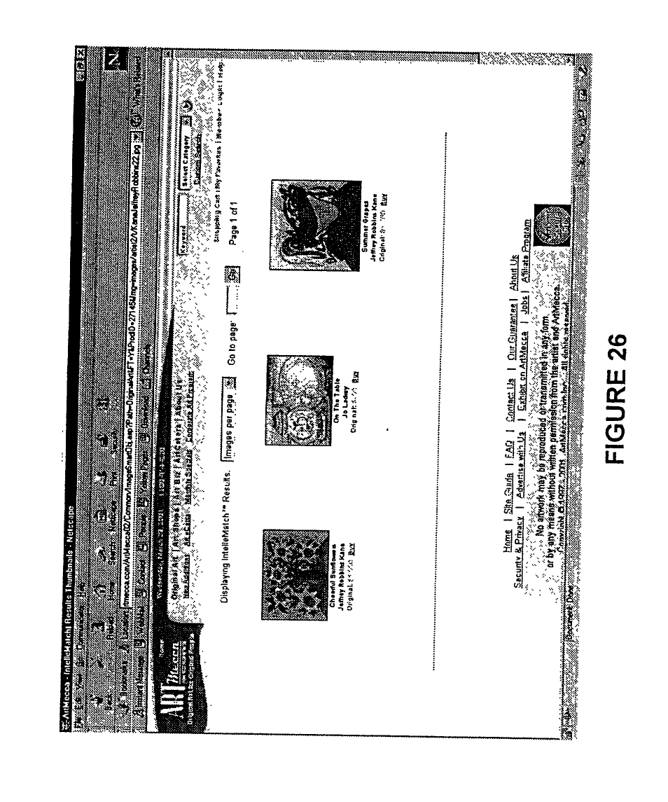

FIGS. 23-26 illustrate an additional example of the visual preference system at work. In FIG. 23 an initial set of items is presented. The user may choose any one of these items, shown in FIG. 24. An “our suggestions” option allows the system to predict artwork that the viewer may like and display artwork that may or may not all be in the same art category, shown in FIG. 25. A “more like this” option allows the system to predict artwork that the viewer may like and display artwork that is all in the same art category, shown in FIG. 26.

In some embodiments a returning Web site customer may be identified either by a cookie stored on their machine or browser during a previous session, or alternatively by retrieving personal information from them such as, for example, a login name or their email address. The system may in some instances use a combination of the two types of data—this allows maximum flexibility in tracking users as they switch from one machine to another, or as multiple users work on a single machine. The system then uses this knowledge to react accordingly, retrieve a users prior preferences, and start the new session with a detailed knowledge of the user's visual preferences.

Although the preceding example illustrates an on-line environment, the invention is equally well-suited to deployment on a client-server, or a standalone platform. In this instance, all prediction processing can be performed on the client machine itself. The database of images can also be stored on the client machine. In this manner the invention may be, for example, distributed with a library of images, clip-art art, fonts, design elements, etc., and used as an integral part of any computer design package, allowing the user to search for and select such images, clip-art, fonts etc. based on their visual preferences and previously determined taste.

Demonstration Tool

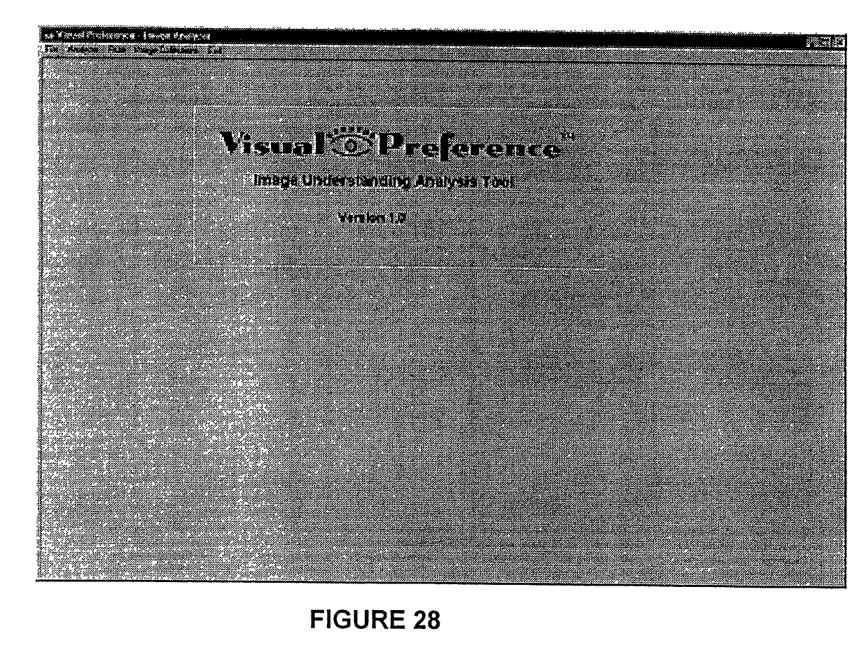

In this section a demonstration tool is disclosed to illustrate the process of the initial batch image understanding, image signature generation, and the systems predictive properties. An example of such a demonstration tool is shown in FIGS. 28-35, while an example of the type of data produced during the batch image processing routines is shown in FIG. 27.

FIG. 28 shows a splash screen of a PC (personal computer) version of the Image Understanding Analysis tool.

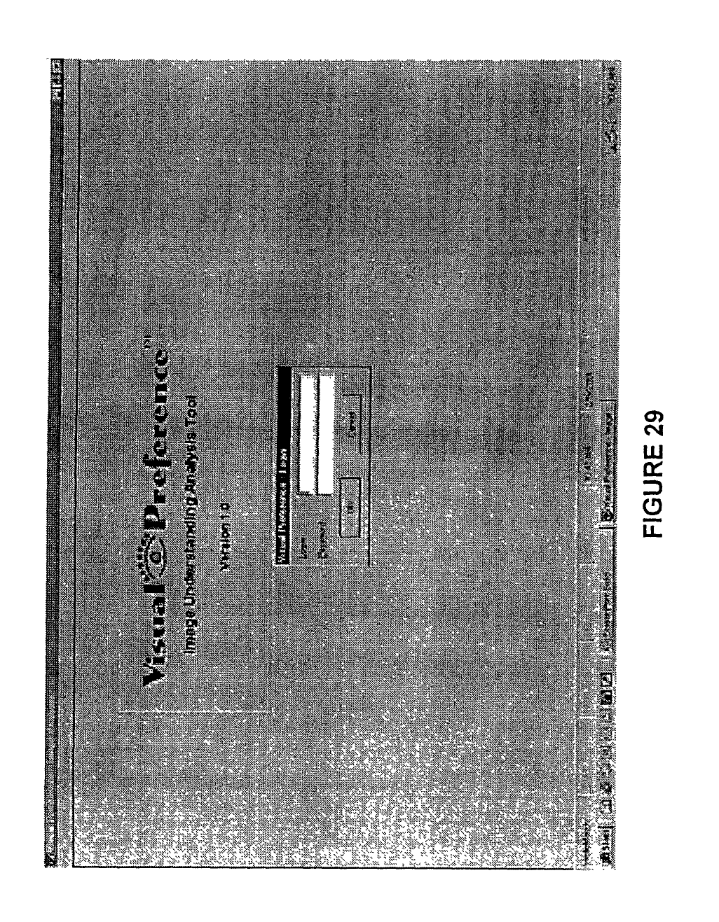

FIG. 29 shows a login and password screen. Once logged in you will be able to process images, change comparison options and view the comparison results.

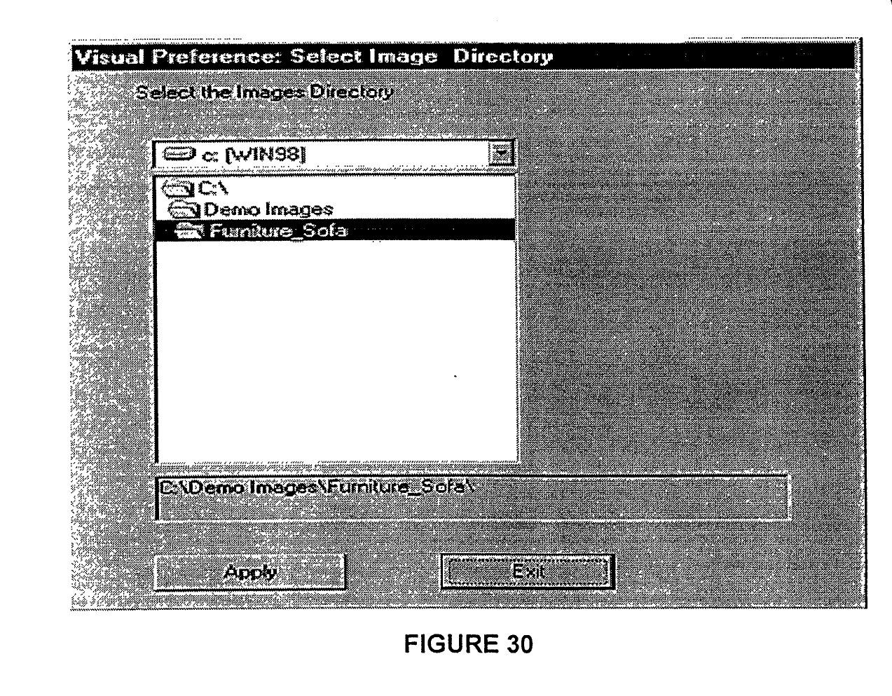

FIG. 30 shows how a user can select the directory that the images are located. The Image Analyzer runs geometric and numeric information on each image.

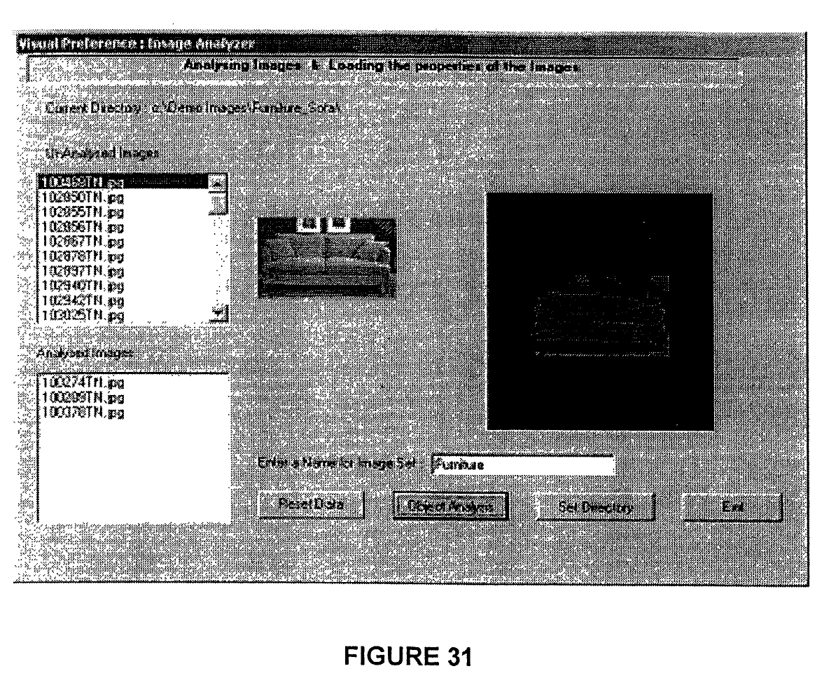

By pressing the Object Analysis each image will be analyzed and it measurement data written into a relational database. FIG. 31 illustrates the process as it is being run.

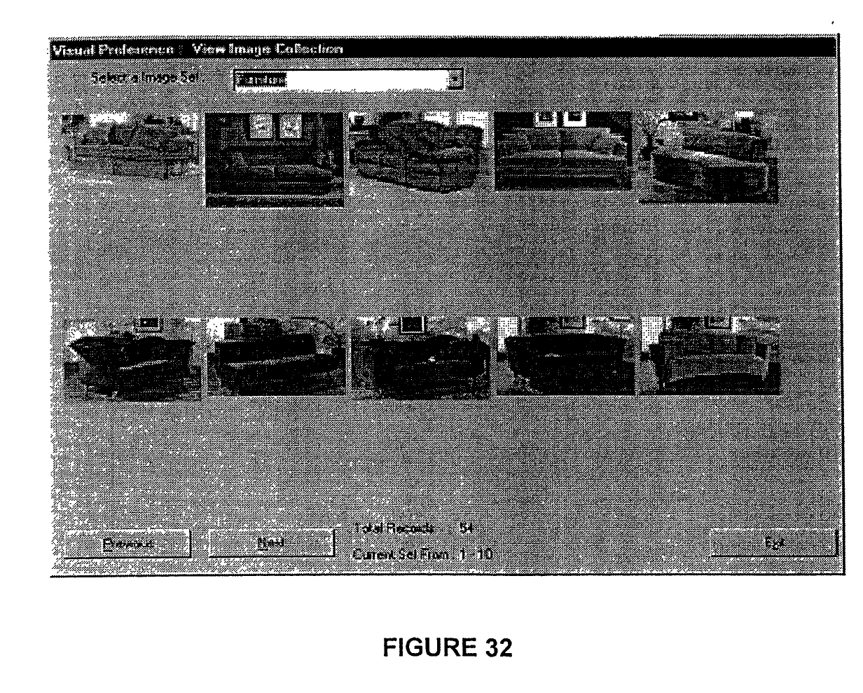

FIG. 32 shows the number of total inventory available (in this example 54 sofas) by paging through the screen and database. This is a preview to what the analyzer has to work with in order to select the attributes and characteristics that would best match the preferences.

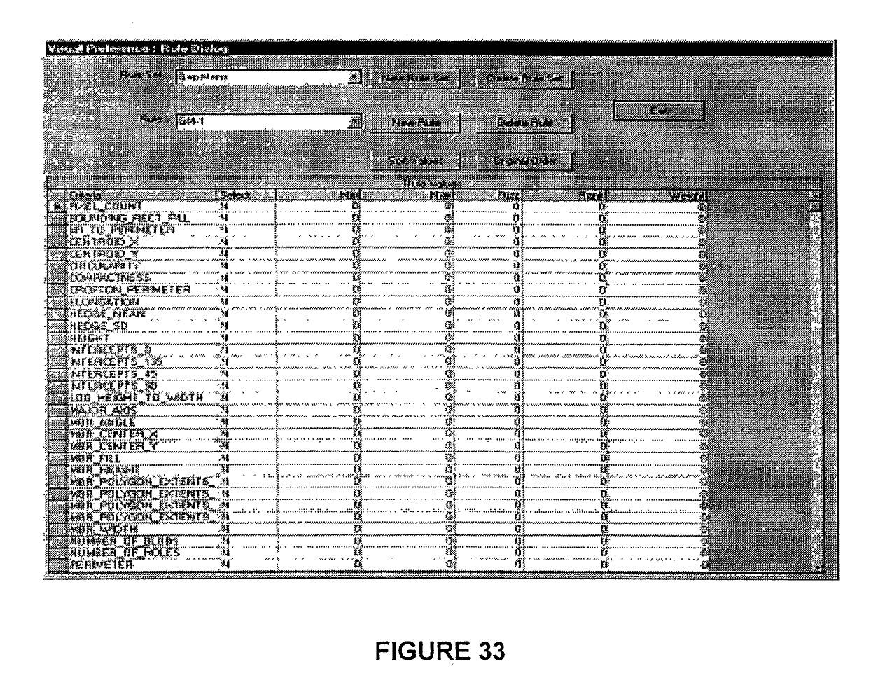

FIG. 33 illustrates the domain characteristics of interest. The value ranges for such variables as characteristics of interest, confidence weight, ranking of importance and a factor for fuzz logic may be pre-set or tunable. Different algorithm can be pre-set then selected in the view dialog screen to view different comparison and selection results.

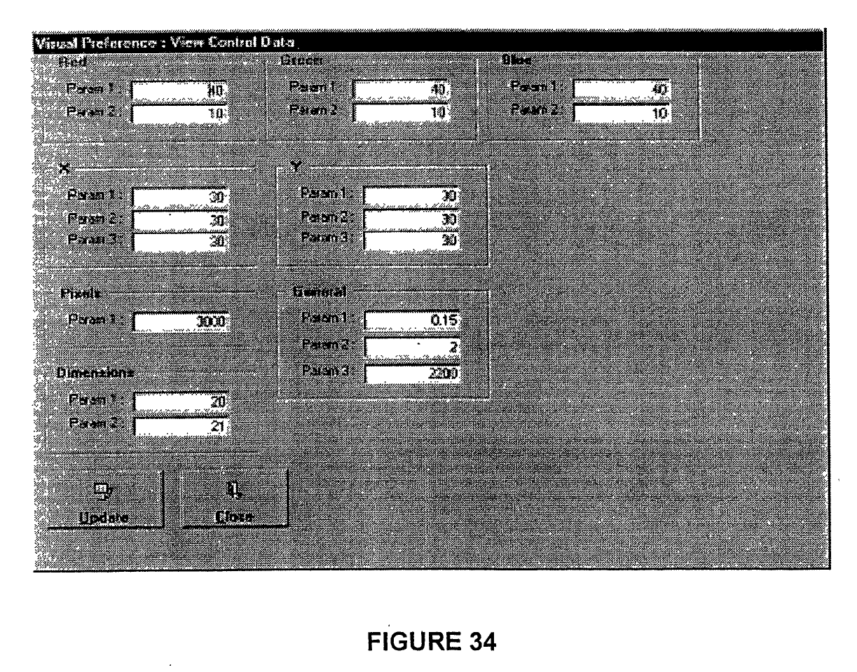

Some default parameters, shown in FIG. 34, can be used to help set the “prior” probabilities.

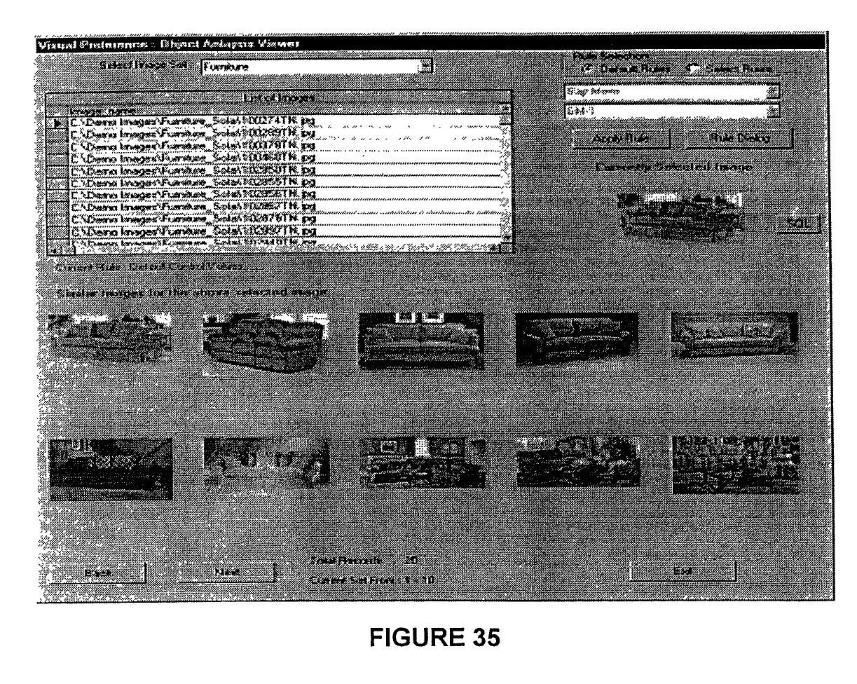

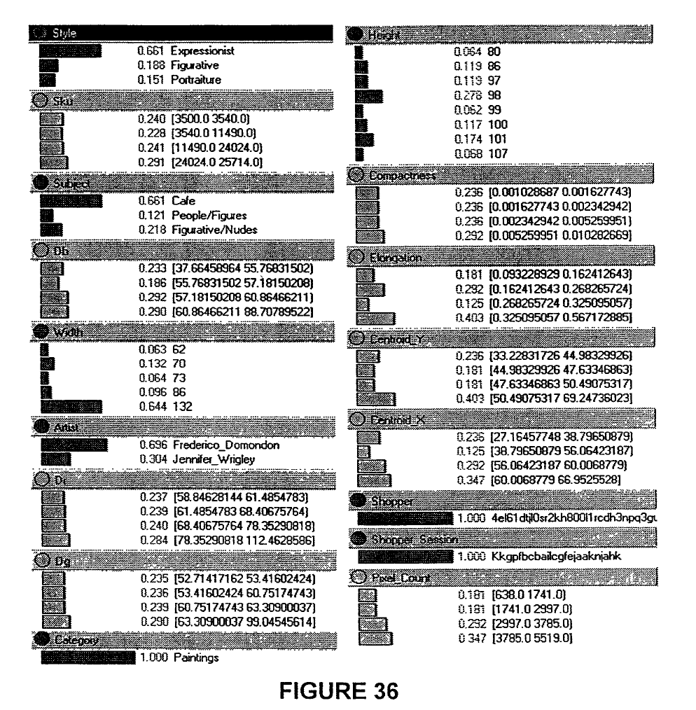

As shown in FIG. 35, the top right sofa is the source of comparison and the bottom two rows are the result of the similar preference and/or comparison. The available sofa in the inventory was 54 and in this example the tool has found 20 that have similar characteristics in the resulting

While the demonstration tool illustrates how the images may be retrieved, processed, and assigned image signatures, it will be evident to one skilled in the art that alternate methods may be used to perform the initial batch processing. Particularly, in some embodiments the image processing may be automatically performed by a computer process having no graphical interface, and that requires no user input. Individual criteria such as pixel_count, and criteria values such as Min, Max, and Fuzz, may be retrieved automatically from configuration files.

Industrial Applicability:

In addition to its real-time predictive abilities, the system may be used to provide other analytical tools and features, including the generation of predictive and historical reports such as:

1. Analytical and ad-hoc reporting with drill down capability

2. Analyzes data in detail, using behavioral and prediction data

3. Reports exceptions conditions in behavioral patterns and trends

4. Graphically displays data and analysis for intuitive comprehension

5. Real-time data in web-based format as well as desktop

6. Cluster Analysis Report

7. Customer Analysis Reports

8. Buying Patterns Reports

9. Customer Ranking Reports

10. Click-through Analysis Reports

11. Customer Retention Rate Report

Embodiments of the invention may include advanced focus search features such as:

1. The ability to mouse over a regional area of interest to narrow down the source search criteria

2. The ability to set up image training sets (search templates) to quickly include or exclude matching images (i.e. face recognition, handwriting recognition, blood cell abnormalities, etc.)

Besides its obvious use in the art shopping embodiment, the invention has many other practical applications, including its use in such industries and applications as:

1. Auto parts selections

2. Auto/boat selection applications

3. Real Estate industries

4. Fashion Catalogs (i.e. Sears, JCPenny, etc)

5. Home furnishing industries

6. Image Stock CDs

7. Photo Catalogs

8. Dating Services applications

9. Face Recognition applications

10. Medical applications

11. Textile industries

12. Vacation industries

13. Art industries

An important application of the invention is in the field of language-independent interfaces. Since the invention allows a user (customer, consumer) to browse and to select items based purely on visual preference, the system is ideally suited to deployment in multilingual environments. The predictive and learning properties of the system allow multiple users to begin with a standard (common) set of items selected from a large inventory, and then, through visual selection alone, to drill down into that inventory and arrive at very different end-points, or end-items. Because the system begins to learn a user's preferences immediately upon the user entering the domain, the user can be quickly clustered and directed along different viewing paths, acknowledging that user as being different from other users, and allowing the system to respond with a different (targeted) content.

Another important application of the invention is in the field of image search engines, and visual search engines. While search engines (both Internet-based, client-server, and standalone application supplied) have traditionally been text-based, the invention allows a user to search using purely visual (non-textual) means. This has direct application in area of publishing and image media, since much of this field relies more on the visual presentation of the item, than on the textual description of the item (which is often inaccurate or misleading). The invention also has direct application in other areas in which visual information is often more important than textual information, and in which a visual search engine is more appropriate than a text search engine—these areas include medical imaging technology, scientific technology, film, and visual arts and entertainment.

The language independence of the invention allows it to be used in any foreign language environment. To best utilize this, embodiments of the invention are modular in nature, appearing as either server engine processes, or as an application software plugin. To use the engine process, a Web site designer may, for example, create a Web site in which the text of the site appears in a particular language (French, Japanese, etc.). The images on the site (the visual content) may however be governed by the visual search engine. Since the user can select images without regard to language, and since the engine process itself is language independent, the Web site designer may incorporate the engine process into the site and take advantage of it's search and prediction abilities, without having to tailor the site content accordingly. In this manner multiple Web sites can be quickly built and deployed that use a different user language textual interface, but an identical underlying system logic, inventory, and searching system.

Operators and Function Descriptions

The following is a list of various image processing operators and function description that can be used with the invention. It will be evident that the following list is not intended to be exhaustive but is merely illustrative of the types of operators that can be used, and that alternative and additional types of image operators may also be used.

| | |
|---|---|
| APHIMGNEW | This function returns a pointer to a new |
| | image instance |
| APHIMGREAD | This operator to read an image into an |
| | aphimage. The supported formats are |
| | tiff, bmp, jpeg, and selected kbvision |
| | formats |
| APHINSTALLATIONPATH | This function returns the complete path |
| | to the directory. |
| APHIMGTHRESHOLD | This operator to threshold the input |
| | image between a lower and upper |
| | bound. |
| | Algorithm: |
| | If (inim(i, j) |
| | ≧ lothresh && inim(i, j) ≦ |
| | hithresh) then |
| | outim(i, j) = 1 |
| | Else |
| | outim(i, j) = 0 |
| | End if |
| | Parameters: |
| | inim—source image |
| | outim—output. Destination image |
| | thresh—threshold values |
| APHIMGERODERECONS- | This operator to erode the source image |
| OPEN | and reconstruct the resulting image |
| | inside the original source image, i.e., |
| | performs geodesic dilations. |
| APHSELEMENT | This operator source the structuring of |
| | an element. |
| APHIMGAREA | This operator computes the area of a |
| | binary image. |
| APHIMGCLUSTERSTO- | This operator produces a region-label |
| LABELS | image from a cluster-label image. |
| | The connectivity considered is the one |
| | defined by the specified graph (4- |
| | connected, 8-connected, etc.). |
| | Algorithm: |
| | A first implementation of this operator |
| | uses a fast two-pass algorithm. The first |
| | pass finds approximate regions by |
| | looking at the previous pixel in x and y. |
| | The second pass resolves conflicting |
| | region labels through a lookup table. |
| | A second implementation uses a queue |
| | of pixels. The whole image is scanned |
| | and when one point belonging to a |
| | connected component (cc) is |
| | encountered, this cc is totally |
| | reconstructed using the queue, and |
| | labeled. |
| APHIMGLABELSOBJ | This operator converts a label image |
| | into a set of regions. The operator |
| | groups all pixels with the same value in |
| | the input image into one region in the |
| | output objectset. |
| | This operator scans the label image one |
| | time to collect the bounding box of each |
| | region. Then it allocates regions and |
| | scans the label image a second time to |
| | set pixels in the region corresponding to |
| | the label at each pixel. The resulting |
| | regions, and their pixel counts, are |
| | stored in the output region set. |
| APHOBJNEW | This function returns a new objectset |
| | object instance. |
| APHIMGCOPY | This operator copies an image to |
| | another image. The entire image is |
| | copied, without regard to any region |
| | area of interest (roi). |
| APHOBJDRAW | This operator draws one spatial attribute |
| | of an objectset in the overlay of an |
| | image. |
| APHOBJ | This function returns an objectset object |
| | instance corresponding to an existing |
| | objectset. |
| APHIMGEXTERNAL- | This operator performs a morphological |
| GRADIENT | edge detection by subtracting the |
| | original image from the dilated image. |
| | Because of its asymmetrical definition, |
| | the extracted contours are located |
| | outside the objects (“white objects”). |
| | Different structuring elements lead to |
| | different gradients, such as oriented |
| | edge detection if line segment |
| | structuring elements are used. |
| APHIMGINFIMUMCLOSE | This operator computes the infimum |
| | (i.e. minimum) of closings by line |
| | segments of the specified size in the |
| | number of directions specified by |
| | sampling. |
| APHIMGWHITETOPHAT | This operator to perform a top hat over |
| | the white structures of the source image |
| | using the supplied structuring element. |
| | Algorithm: |
| | if o stands for the opening by se, the |
| | white top hat wth is defined as: |
| | Wth(im) = im − o(im) |
| | Parameters: |
| | inim—source image |
| | outim—destination image |
| | se—structuring element |
| APHIMGSUPREMUMOPEN | This operator computes the supremum |
| | (i.e., maximum) of openings by line |
| | segments of the specified size in the |
| | number of directions specified by |
| | sampling. |
| APHIMGOR | This operator performs logical or of two |
| | images. The output roi is the inter- |
| | section of the input rois. |
| APHIMGFREE | This operator closes an image and free |
| | it from memory. |
| APHIMGNOT | This operator performs logical not of an |
| | image. |
| APHIMGHOLEFILL | This operator fills the holes present in |
| | the objects, i.e. connected components, |
| | present in the input (binary) image. |
| APHIMGCLUSTERSSPLIT- | This operator splits overlapping convex |
| CONVEX | regions. The filterstrength parameter is |
| | valued from 0 to 100 and allows tuning |
| | of the level above which a concavity |
| | creates a separation between two |
| | particles. |
| | Algorithm: |
| | filter strength/100 * maximum distance |
| | function/2 |
| APHIMGSETTYPE | This function sets the data type of an |
| | image (i.e., scalar type of the pixels). |
| APHIMG | This function returns an image object |
| | instance corresponding to an existing |
| | image. |
| APHIMGNORMALIZEDRGB | This operator computes a set of |
| | normalized rgb color images from rgb |
| | raw images. The operator takes a tuple |
| | image inim as an input color image |
| | which stores red, green, and blue raw |
| | images in the band 1, band 2 and band 3 |
| | of the inim, respectively. The output |
| | tuple image outim stores the normalized |
| | rgb color image in its three bands. Band |
| | 1 stores normalized red images. Band 2 |
| | stores normalized green images. Band 3 |
| | stores normalized blue images. |
| | Algorithm: |
| | Let r, g, and b be the values of red, |
| | green, and blue images at a pixel |
| | location and let variable total and |
| | totnozero be |
| | total = r + g + b; |
| | totnozero = (total == 0? 1:total); |
| | then, |
| | normalized red image = r/totnozero; |
| | normalized green image = g/totnozero; |
| | normalized blue image = b/totnozero; |
| | Parameters: |
| | inim—input color image |
| | outim—output normalized-rgb-color |
| | image |
| APHIMGMORPHGRADIENT | This operator performs a morphological |
| | edge detection by subtracting the eroded |
| | image from the dilated image. |
| APHTHRESHOLD | This function returns a threshold object |
| | instance that can be used as a parameter |
| | of a thresholding operator. |
| APHOBJCOMPUTE- | This operator computes a variety of |
| MEASUREMENTS | measurements for a number of different |
| | spatial objects. It computes texture, |
| | shape, and color measurements for |
| | regions. It will compute length, |
| | contrast, etc. for lines. |
| APHMEASUREMENTSET | This function returns the measurement |
| | selection object instance corresponding |
| | to the global measurement |
| | selection settings existing in the system. |
| APHIMGMAXIMUMCON- | This operator produces a set of regions |
| TRASTTHRESHOLDOBJ | from the output of aphimgmaximum- |
| | contrastthreshold operator. |
| | Algorithm: |
| | Call the aphimgmaximumcontrast- |
| | threshold operator and then produce a |
| | set of regions from the image created by |
| | aphimgmaximumcontrastthreshold |
| | operator. |
| APHIMGCOLORTHRESHOLD | This operator threshold the input |
| | colored image between lower and upper |
| | bounds. |
| | Algorithm: |
| | If (inim(i, j) |
| | ≧ lothresh && inim(i, j) ≦ hithresh) |
| | then |
| | outim(i, j) = 1 |
| | Else |
| | outim(i, j) = 0 |
| | End if |
| | Parameters: |
| | inim—source image. |
| | outim—output. Destination image. |
| | thresh—threshold values for rgb or hsi. |
| | colorspace—0 for rgb, 1 for hsi. |
| APHIMGCLOSE | This operator performs a morphological |
| | closing of the source image using the |
| | supplied structuring element |
| | Algorithm: |
| | If e stands for the erosion by se, and d |
| | stands for the dilation by the transposed |
| | structuring element, the closing c is |
| | defined as: |
| | C(im) = e(d(im)) |
| | Parameters: |
| | inim—source image |
| | outim—destination image |
| | se—structuring element |
| APHIMGMEDIAN | This operator performs median filtering |
| | on an image |
| | Algorithm: |
| | The median is the value which occurs at |
| | the middle of the population when the |
| | operator sorts by value. Mask values are |
| | integers which indicate how many time |
| | the operator counts each underlying |
| | pixel value as part of the population. |
| | When there is an even population, the |
| | algorithm selects the value of the |
| | individual on the lower side of the |
| | middle. |
| | Parameters: |
| | inim—input image |
| | outim—output image |
| | kernel—kernel |

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A visual search and selection system for allowing a user to visually search for an item or select from an inventory of items, comprising:
an image analyzer for analyzing an image of each item within the inventory of items and associating therewith an image signature identifying the visual characteristics of said item;
an item selection interface for displaying to a user a set of images associated with a subset of said inventory of items and allowing said user to select an item from said subset;
a visual preference logic for calculating a users likely preference for other items in the inventory based upon their selection from said subset of items, and the visual characteristics of said selection.

2. The visual search and selection system of claim 1 wherein said visual preference logic includes a predictive logic for predicting the likelihood of future items being selected by said user from said inventory.

3. The visual search and selection system of claim 2 wherein the predictive logic is used to generate a new subset of items from which the user may select.

4. The visual search and selection system of claim 1 wherein said visual preference logic includes a behavioral tracking logic for analyzing the users selections, and associating said user with a behavioral cluster.

5. The visual search and selection system of claim 1 wherein selected components of the visual search and selection system operate on a computer system, and wherein a client application running on said computer system is used to control said item selection interface.

6. The visual search system and selection system of claim 5 wherein the inventory of items is stored on a first computer system, and wherein the item selection interface and visual preference logic operates on a second computer system.

7. The visual search and selection system of claim 1 wherein the visual search and selection system is an on-line system, and wherein the system receives selection information from a Web page, and returns new subset information to a Web page.

8. The visual search and selection system of claim 6 wherein the visual search system is accessed by the user via a Web browser.

9. The visual search and selection system of claim 7 wherein the user is identified by a combination of a cookie stored on their machine or browser during a previous session, and by personal information retrieved from the user, and wherein the system uses this knowledge to retrieve a users prior preferences, and start a new session with a detailed knowledge of the user's visual preferences.

10. The visual search and selection system of claim 8 wherein said inventory of items includes any of auto parts, auto/boat selections, real estate, fashion items, home furnishings, image stock cd's, photographs, faces, medical images, textiles, vacation pictures, and art pieces.

11. A method for allowing a user to visually search for an item or select from an inventory of items, comprising:
analyzing, using an image analyzer, an image of each item within the inventory of items and associating therewith an image signature identifying the visual characteristics of said item;
displaying, using an item selection interface, to a user a set of images associated with a subset of said inventory of items and allowing said user to select an item from said subset;
calculating, using a visual preference logic, a users likely preference for other items in the inventory based upon their selection from said subset of items, and the visual characteristics of said selection.

12. The method of claim 11 wherein said visual preference logic includes a predictive logic for predicting the likelihood of future items being selected by said user from said inventory.

13. The method of claim 12 wherein the predictive logic is used to generate a new subset of items from which the user may select.

14. The method of claim 11 wherein said visual preference logic includes a behavioral tracking logic for analyzing the users selections, and associating said user with a behavioral cluster.

15. The method of claim 11 wherein selected components of the visual search and selection system operate on a computer system, and wherein a client application running on said computer system is used to control said item selection interface.

16. The method of claim 15 wherein the inventory of items is stored on a first computer system, and wherein the item selection interface and visual preference logic operates on a second computer system.

17. The method of claim 11 wherein the visual search and selection system is an on-line system, and wherein the system receives selection information from a Web page, and returns new subset information to a Web page.

18. The method of claim 16 wherein the visual search system is accessed by the user via a Web browser.

19. The method of claim 17 wherein the user is identified by a combination of a cookie stored on their machine or browser during a previous session, and by personal information retrieved from the user, and wherein the system uses this knowledge to retrieve a users prior preferences, and start a new session with a detailed knowledge of the user's visual preferences.

20. The method of claim 18 wherein said inventory of items includes any of auto parts, auto/boat selections, real estate, fashion items, home furnishings, image stock cd's, photographs, faces, medical images, textiles, vacation pictures, and art pieces.
